(19) United States
(12) Patent Application Publication
(10) Pub. No.: US 2024/0039333 A1
(43) Pub. Date: Feb. 1, 2024

(54) ELECTROMAGNETIC HEATING SYSTEM

(71) Applicant: Kamil Podhola, Liberec (CZ)

(72) Inventor: Kamil Podhola, Liberec (CZ)

(21) Appl. No.: 17/877,627

(22) Filed: Jul. 29, 2022

(51) Int. Cl. H02J 50/10; H05B 6/10; H02J 50/40; H05B 6/44

(52) U.S. Cl. CPC H02J 50/10; H05B 6/10; H02J 50/40; H05B 6/44

(57) ABSTRACT

The invention relates to an electromagnetic heating system (EHS) comprising a primary electromagnetic interface including one or more primary coils and a secondary electromagnetic interface including one or more secondary coils wherein a wireless power transfer can be provided between the primary and the secondary electromagnetic interfaces. The primary and/or the secondary coils can be configured to produce heat which can heat vehicles, water vessels, constructions, foods and drinks, human bodies, animal bodies, plants. The EHS can include defined electrocomponents. The coils can form heating oscillators. The system can include repeating interfaces and can be coupled with other heating systems. The system can be buoyant, provided with an insulation, a heat accumulating material, it can be modularly configured. An electromagnetic heating method is proposed for proximity or vicinity heating. A microwave heating method is proposed for systems and/or apparatuses combining microwave energy producing, conducting and in heat transforming functions.

### TECHNICAL FIELD

The invention relates to an electromagnetic heating system, an electromagnetic heating method and a microwave heating method.

### BACKGROUND ART

U.S. Pat. No. 2,063,342A (Bell Telephone Laboratories Inc. 8 Dec. 1934 (1934-12-08) discloses electron discharge devices adapted for the generation and amplification of ultrahigh frequency impulses and discloses magnetrons comprising a cathode, an anode, and means for producing a magnetic field about the cathode, inductances and capacitances forming circuits resonant at the intended frequency.

US 20050225128A1 (BrainCOM AG [D]) 21 Dec. 2001 (2001-12-21) discloses surface heating system and method with a supported heating layer, which contains electrically conducting plastic, characterized by the fact that the heating layer is formed from a flexible film, and that the support is flexible.

International Application No. PCT/IB2021/054328, filed 19 May 2021 (19-05-2021) and National Phase US 17/735,163 (Kamil Podhola 05/03/2022) co-pending patent application, Title, “WIRELESS ELECTROMAGNETIC ENERGY TRANSFER SYSTEM” discloses a wireless electromagnetic energy transfer system comprising primary and secondary magnetic elements spaced apart from each other to be able to transfer circular magnetic fluxes created by primary and secondary conductors disposed at about or in the primary and secondary magnetic elements.

The documents fail to disclose an electromagnetic heating system using wireless energy transfer, an electromagnetic heating method using an electromagnetic conductor and a microwave heating method.

### DISCLOSURE OF INVENTION

There is a need for an effective, simple, cheap and lightweight heating system and a method based on a wireless energy transfer.

There is a need for a combined microwave energy generating, conducting and heating method.

It is an object of the present invention to provide an electromagnetic heating system (EHS) comprising a primary electromagnetic interface including one or more primary coils and a secondary electromagnetic interface including one or more secondary coils, wherein a wireless power transfer may be provided between the primary and the secondary electromagnetic interface, the electromagnetic heating system characterised in that the primary and/or the secondary coils may be configured to produce heat.

It is another object to provide the EHS using an inductive power transfer, a capacitive power transfer, a magnetodynamic power transfer, an electromagnetic power transfer, resonant power transfer, non-resonant power transfer, or combinations.

It is another object to provide the EHS configured to heat a defined object in a vehicle or in a water vessel.

It is another object to provide the EHS configured to heat a defined construction.

It is another object to provide the EHS configured to heat a food and/or a drink.

It is another object to provide the EHS configured to heat a defined body.

It is another object to provide the EHS provided with a heat dissipating device.

It is another object to provide the EHS coupled with an electrocomponent.

It is another object to provide the EHS forming an oscillator.

It is another object to provide the EHS configured to use resonant and/or harmonic frequencies.

It is another object to provide the EHS further comprising a repeating electromagnetic interface.

It is another object to provide the EHS further providing an electromagnetic coupling regulation.

It is another object to provide the EHS thermally coupled with a defined heating system.

It is another object to provide the EHS configured to be at least partially buoyant.

It is another object to provide the EHS provided with an insulation.

It is another object to provide the EHS provided with a heat accumulating material.

It is another object to provide the EHS modularly exchangeable and/or scallable.

It is yet another object to provide an electromagnetic heating method for a heating system comprising a primary electromagnetic interface including one or more primary coils and a secondary electromagnetic interface including one or more secondary coils, the method characterised in that it may comprise:
the step of providing an electromagnetic field by said one or more primary coils;
the step of providing an electromagnetic power transfer between at least one of the one or more primary coils and at least one of the one or more secondary coils;
the step of dissipating heat from at least one of the one or more primary coils and/or from at least one of the one or more secondary coils,
wherein the steps can be interchanged and/or repeated.

It is yet another object to provide a microwave heating method for a heating system comprising a primary electromagnetic interface including or coupled with a microwave energy generator and a secondary electromagnetic interface including one or more electromagnetic conductors, the method may be characterised in that it may comprise:
the step of providing the microwave energy by means of the microwave energy generator;
the step of conducting the microwave energy by the one or more electromagnetic conductors;
the step of transforming electromagnetic wave into heat.

It is another object to provide the microwave heating method with the electromagnetic conductors configured to have the same or substantially the same resonant frequency the primary electromagnetic interface.

In a first aspect, the invention discloses an electromagnetic heating system.

In a second aspect, the invention discloses an electromagnetic heating method.

In a third aspect, the invention discloses a microwave heating method.

### BRIEF DESCRIPTION OF DRAWINGS

The invention will now be described by way of example. Only essential elements of the invention are schematically shown and not to scale to facilitate immediate understanding, emphasis being placed upon illustrating the principles of the invention.

FIG. 1 is an oblique view of two electromagnetic heating coils according to the present invention.

FIG. 2 is a cross sectional view of five electromagnetic heating coils according to the present invention.

FIG. 3 is a cross sectional view of the system shown in FIG. 2 with regulation.

FIG. 4 is a schematic plan view of an air cooled electromagnetic heating system for heating an electric vehicle.

FIG. 5 is a schematic plan view of an embodiment of a liquid cooled electromagnetic heating system for heating an electric vehicle.

FIG. 6 is a diagram of an embodiment of three electromagnetic heating coils forming LC oscillators.

FIG. 7 is a schematic oblique view of another embodiment of heating oscillators encapsuled in an envelope.

FIG. 8 is a schematic oblique view of another embodiment of heating oscillators coupled with an antenna.

FIG. 9 is a schematic oblique view of another embodiment of a heating oscillator with an antenna and at a box.

FIG. 10 is a schematic perspective view of another embodiment of a heating oscillator provided at a heating bag.

FIG. 11 is a schematic side view of another embodiment of a heating oscillator provided at a heating bottle.

FIG. 12 is a schematic perspective view of another embodiment of an electromagnetic heating system configured to heat a pool.

FIG. 13 is a schematic perspective view of another embodiment of an electromagnetic heating system configured to heat conduits.

FIG. 14 is a schematic plan view of another embodiment of an electromagnetic heating system configured to heat a construction.

FIG. 15 is a schematic perspective view of another embodiment of an electromagnetic heating system coupled with a house (green) energy system and configured to heat a roofing construction.

FIG. 16 is a schematic side view of another embodiment of an electromagnetic heating system which can warm an animal body.

FIG. 17 is a schematic perspective view of another embodiment of an electromagnetic heating system which can heat an animal bed.

FIG. 18 is a schematic perspective view of another embodiment of an electromagnetic heating system which can heat a conditioning hair heat cap.

FIG. 19 is a schematic perspective view of another embodiment of an electromagnetic heating system which can heat a car seat.

FIG. 20 is a schematic perspective view of another embodiment of an electromagnetic heating system which can heat (warm up, dry up) a fabric towel.

FIG. 21 is a schematic perspective view of another embodiment of an electromagnetic heating system which can heat a swaddle.

FIG. 22 is a schematic front view of another embodiment of an electromagnetic heating system which can heat a steering wheel.

FIG. 23 is a schematic front view of another embodiment of an electromagnetic heating system which can heat a wheel.

FIG. 24 is a schematic perspective view of another embodiment of an electromagnetic heating system which can heat a mug.

FIG. 25 is a schematic perspective view of another embodiment of an electromagnetic heating system which can heat a shoe.

FIG. 26 is a schematic perspective view of another embodiment of an electromagnetic heating system which can heat a car cover.

FIG. 27 is a schematic perspective view of another embodiment of an electromagnetic heating system which can heat a body heat therapy band.

FIG. 28 is a schematic perspective view of another embodiment of an electromagnetic heating system which can heat an outdoor advertising mean.

FIG. 29 is a schematic oblique view of another embodiment of an electromagnetic heating system which can dry up sheets.

FIG. 30 is a schematic perspective view of another embodiment of an electromagnetic heating system which can preheat an electric car.

FIG. 31 is a schematic diagram of another embodiment of an electromagnetic heating system shown in a pulse width modulation (PWM) topology.

FIG. 32 is a schematic perspective view of another embodiment of an electromagnetic heating system which can heat a car interior.

FIG. 33 is a schematic diagram of another embodiment of an electromagnetic heating system in a full-bridge inverter topology.

FIG. 34 is a schematic perspective view of another embodiment of an electromagnetic heating system which can heat clothing while weared or not.

FIG. 35 is a schematic diagram of another embodiment of an electromagnetic heating system in a power amplifier topology.

FIG. 36 is a schematic diagram of another embodiment of an electromagnetic heating system in a power amplifier topology (inductive power transfer).

FIG. 37 is a schematic perspective view of another embodiment of an electromagnetic heating system which can warm a bottled drink.

FIG. 38 is a schematic perspective view of another embodiment of an electromagnetic heating system which can warm canned food.

FIG. 39 is a schematic perspective view of another embodiment of an electromagnetic heating system in a compact packaging.

FIG. 40 is a schematic exploded perspective view of another embodiment of an electromagnetic heating system producing microwave energy.

FIG. 41 is a functional perspective illustration of an apparatus which can provide the proposed microwave heating method for a heating system including a waveguide.

FIG. 42 is a functional perspective illustration of another apparatus which can provide the proposed microwave heating method for a heating system including a double waveguide.

FIG. 43 is a functional perspective illustration of another apparatus which can provide the proposed microwave heating method for a heating system including a heating flared type horn antenna.

FIG. 44 is a functional partial perspective illustration of another apparatus which can provide the proposed microwave heating method for a heating system including irregularly shaped exterior heat sinks.

FIG. 45 is a cross sectional view of examples of heat sinks shapes which can be used in the present invention.

FIG. 46 is a functional perspective illustration of another apparatus which can provide the proposed microwave heating method for a heating system including exterior and interior heat sinks.

FIG. 47 is a functional oblique view of another apparatus which can provide the proposed microwave heating method for a heating system including a heating interior hole.

FIG. 48 is a functional oblique view of another apparatus which can provide the proposed microwave heating method for a heating system providing a surface heating cartridge.

FIG. 49 is a schematic perspective illustration of another apparatus which can provide the proposed microwave heating method for a heating system including a pair of microwave energy generators.

FIG. 50 is a functional perspective illustration of another apparatus which can provide the proposed microwave heating method for a heating system including a pair of semicircular heating electromagnetic interfaces.

FIG. 51 is a functional perspective illustration of another apparatus which can provide the proposed microwave heating method for a heating system including an air flow heating system.

FIG. 52 is a functional perspective illustration of an electromagnetic heat sink.

FIG. 53 are plan views of resonant electromagnetic heat sinks.

FIG. 54 is a schematic oblique view of an electromagnetic heat sink block.

FIG. 55 is a schematic oblique view of another apparatus which can provide the proposed microwave heating method for a heating system which can heat a heating plate.

FIG. 56 is a partial functional oblique view of an electromagnetic heat sinks blok.

FIG. 57 is a partial functional oblique view of electromagnetic oscillating conductor layers.

FIG. 58 is a partial functional oblique view of an electromagnetic conductor layer's separated oscillating portions.

FIG. 59 is a partial functional oblique view of a hollow electromagnetic conductor layer.

FIG. 60 is a partial functional oblique view of electromagnetic conductor layers.

FIG. 61 are plan views of heating electromagnetic conductors.

FIG. 62 is a functional perspective illustration of another apparatus which can provide the proposed microwave heating method for a heating system including air and liquid heating systems.

FIG. 63 is a plan view of another apparatus which can provide the proposed microwave heating method for a heating built-in system.

FIG. 64 is an oblique view of a finned heating cover.

FIG. 65 is a functional schematic of the principle of the proposed method.

FIG. 66 is a schematic oblique view of another apparatus which can provide the proposed microwave heating method for a heating system providing a microwave heated chamber.

FIG. 67 is a partial functional perspective illustration of a rotatably coupled hollow electromagnetic conductor.

FIG. 68 is a functional perspective view of a hollow electromagnetic heating conductor.

FIG. 69 is a perspective view of a heating horn antenna.

FIG. 70 is a schematic perspective view of another apparatus which can provide the proposed microwave heating method for a heating system including a pair of electromagnetic heating conductors.

FIG. 71 is a schematic perspective view of another apparatus which can provide the proposed microwave heating method for a heating system including a freedom joint couplable electromagnetic conductor.

FIG. 72 is a variant of the embodiment shown in FIG. 71 with an electromagnetic conductor including heat sinks.

FIG. 73 is a variant of the embodiment shown in FIG. 71 with an electromagnetic conductor coupled with a hat sink.

FIG. 74 is a functional schematic of the principle of the proposed method.

FIG. 75 is a schematic interior perspective view of another apparatus which can provide the proposed microwave heating method for a heating system including electromagnetic conductors with interior oscillating (heating) structures.

FIG. 76 is a schematic perspective view of another apparatus which can provide the proposed microwave heating method for a heating system including a freedom joint coupled electromagnetic heating conductor.

FIG. 77 is a schematic side view of modularly scallable and exchangeable electromagnetic conductors.

FIG. 78 is a schematic side view of a combined electromagnetic heat exchanger.

FIG. 79 is a schematic oblique view of an electromagnetic heat exchanger.

FIG. 80 is a schematic oblique view of an electromagnetic heating spiral.

FIG. 81 is a schematic oblique view of a microwave water heater.

FIG. 82 is a schematic oblique view of a heating electromagnetic network coupler.

FIG. 83 is a schematic plan view of an apparatus which can provide the proposed electromagnetic heating method for a heating system including a rotating electric energy generator.

FIG. 84 is a schematic plan view of basic components of an apparatus which can provide the proposed electromagnetic heating method.

FIG. 85 is a schematic perspective view of a heating bedcloth apparatus which can provide the proposed electromagnetic heating method.

FIG. 86 is a schematic perspective view of a heating folding box which can provide the proposed electromagnetic heating method.

FIG. 87 is a schematic perspective view of a heating bag which can provide the proposed electromagnetic heating method.

FIG. 88 is a schematic perspective view of a heating sofa which can provide the proposed electromagnetic heating method.

FIG. 89 is a schematic perspective view of a heating door mat which can provide the proposed electromagnetic heating method.

FIG. 90 is a schematic perspective view of another apparatus which can provide the proposed microwave heating method for a heating system comprising a heat working surface.

FIG. 91 is a schematic oblique view of another apparatus which can provide the proposed microwave heating method for a heating system comprising a heating socket wrench.

FIG. 92 is a schematic oblique view of another apparatus which can provide the proposed microwave heating method for a heating system comprising heating sockets.

FIG. 93 is a schematic oblique view of another apparatus which can provide the proposed microwave heating method for a heating system comprising a heat cutting knife.

FIG. 94 is a schematic oblique view from the bottom of another apparatus which can provide the proposed microwave heating method for a heating system comprising an asphalt microwave heater.

FIG. 95 is a schematic oblique view of another apparatus which can provide the proposed microwave heating method for a heating system comprising heat forming means.

FIG. 96 is a schematic plan view of a heating HVAC system which can provide the proposed electromagnetic heating method.

FIG. 97 is a schematic perspective view of a can heating system which can provide the proposed electromagnetic heating method.

FIG. 98 is a schematic perspective view of a heating nut which can provide the proposed electromagnetic heating method.

FIG. 99 is a schematic front view of a heating radiator which can provide the proposed electromagnetic heating method.

FIG. 100 is a schematic perspective view with a partial cutout of a heating cable/induction heating unit which can provide the proposed electromagnetic heating method.

FIG. 101 is a schematic perspective view of a hater matrix/induction baking unit which can provide the proposed electromagnetic heating method.

### BEST MODE FOR CARRYING OUT THE INVENTION

The following detailed description shows the best contemplated modes of exemplary embodiments. The description is made for the purpose of illustrating the general principles of the invention, and in such a detail that a skilled person in the art can recognise the advantages of the invention, and can be able to make and use the invention. However, it will be apparent to one of ordinary skill in the art that these specific details need not be used to practice the present invention. Well-known structures, materials, circuits, processes have not been shown or described in detail in order not to unnecessarily obscure the present invention. The objects and advantages of this invention may be realized and obtained as pointed out in the appended claims. Advantageous embodiments are the subject of the description, the figures and the dependent claims. Additional advantages may be learned by practice of the invention. The detailed description is not intended to limit the principle of the presented invention, but only to show the possibilities of it. The description and the detailed description are exemplary and explanatory only.

The terms used in the claims and the specification shall refer to their synonyms as well.

The terms in the description put into parentheses show another variant, aspect, possibility, etc., of an element, feature, component, etc., of the invention.

As used in the claims and the specification, the term ““coils” shall refer to any geometric shape and winding diagram able to wirelessly transfer energy, shall refer to a coiled electrical conductor, a wound electrical conductor, a winding, etc., and shall refer to any material, type, size, shape, cross-section, shall refer to conductors providing tuning possibilities and to mutually oriented [e.g. in pairs] conductors, shall also refer to conductors with low proximity losses, nanostructures, shall refer to electrically conductive plastic [e.g. Polyurethane including carbone, etc.] and shall refer to structures formed by any technique including crystal and structure growth techniques. The conductors may be of good conductor materials, high conductivity materials, etc. The conductors may be covered with a material with high electrical conductivity as radio frequency (RF) current with RF energy flows mostly around the surface of the conductor. The conductors may be wires, tressed wires, stranded wires, fibers, sheets, plates, bands, tubes, hollow (cavity) profiles, shaped profiles, rods, strips, microstrips, striplines, lines, ribbons, gels, inks, paints, traces [which can have various cross sections, aspect ratio and which can form stranded traces], printed circuit boards, nanostructures, etc., and may have any form of the conductive path. A cross-section of full profiles, hollow profiles, shaped or formed profiles may have any form [e.g. circular, oval, squared, irregular, geometrical shapes, polygonal, etc.]. The conductors may be of copper wire, copper tubing, other metals or metal alloys, conductive polymers, etc., and may be optically transparent. The conductors may have coupling nodes, feed points [which can be represented by tabs, extensions, etc.], which may be positioned in any position [e.g. in a center of the length, at the ends, etc.], coupling ports which can be coupled with a port parameter measurement circuitry which can measure heat, ambient heat, induced heat, scattering, impedance, admittance, chain, cascade, transmission, parameters, etc. The port parameter measurement circuitry may be coupled with a processor in a control system, e.g. to adjust a pulse width modulator, a power amplifier, an inverter, an adjustable impedance circuitry, etc. The conductors may be oriented substantially parallel or perpendicular to a coupling surface, or in any other direction. The conductors may form various paths [e.g. direct parallel, meandering, loops, “O”, “8”, double and multiple shapes or forms, etc.]. The term may also refer to semiconductors, semiconductor layers and may refer to gallium arsenide, indium arsenide, indium phosphide, indium antimonide, graphene, silicon, germanium, combinations, and the like.

As used in the claims and the specification, the term “power transfer” shall refer to energy transfer, data transfer, signal transfer, etc. The term signal transfer shall refer to a carrier signal, an unmodulated signal, a modulated signal, etc.

As used in the claims and the specification, the term “vehicle” shall preferably refer to a highway car, passenger car, bus, truck, and the like and shall refer to an on shore vehicle, an aerial vehicle, to a vehicle at least partially electrically driven.

As used in the claims and the specification, the term “electric motor” shall refer to any constructional type inclusive of AC, DC motors, other motors/e.g. stepper motors, brushless motors, hysteresis motors, reluctance motors, universal motors, linear motors, etc., jet engines, turbines, etc.

As used in the claims and the specification, the term “electric energy generator” shall also refer to electric devices providing a function of an electric motor and of an electricity generator, and shall also refer to electric devices providing regenerative braking, and shall also refer to electric devices coupled with (output, input) shafts, gears, transmissions, clutches, driven wheels, etc., and shall refer to alternators, alternator rectifiers, dynamos, etc.

As used in the claims and the specification, the term “rechargeable power source” shall preferably not exclusively refer to power sources including rechargeable batteries [e.g. strings, packs, modules, cells], capacitors [e.g. strings, packs, modules, cells], hybrid sources, energy storage elements [e.g. mechanical (e.g. compressed air, compressed gas, flywheel, etc.), electromagnetical (e.g. using superconductors, etc.), electrochemical (e.g. flow battery, ultrabattery, etc.), thermal (e.g. phase change material, cryogenic energy storage, liquid nitrogen engine, etc.), chemical (e.g. biofuel storage, power to gas storage, power to liquid, hydrogen storage/e.g. condensed polycyclic hydrocarbons, metal hydrides, etc., hydrogen peroxide, etc.); a number of hydrogen storage methods can be used: adsorptive, absorptive, as liquid/e.g. at very low temperatures and under high pressure, as highly compressed gas.]. Rechargeable power sources can provide peak shaving, e.g. for an optimum engine fuel consumption.

The term shall refer to a swappable rechargeable power source as well.

As used in the specification, the term “rechargeable battery” shall preferably not exclusively refer to lithium-ion, lithium-ion polymer, lithium-air, lithium-sulphur, lithium-metal, lithium iron phosphate, nickel-metal hydride, nickel-iron, nickel-cadmium, lead-acid, valve regulated lead-acid, absorbed glass mat, gel [e.g. for high pressure, high temperature implementations], solid state, organic radical batteries. Rechargeable batteries may include fuel cells, piezoelectric elements, springs. A variety of arrangements of multiple rechargeable batteries may be used. The rechargeable batteries may be trickle, float charged, charged at fast, slow rates, etc.

As used in the specification, the term “capacitor” shall preferably not exclusively refer to supercapacitors, ultracapacitors, double-layer capacitors (e.g. with activated carbons, carbon aerogels, carbon nanotubes, nanoporous carbon, graphene, carbid-derived carbon), pseudocapacitors (e.g. with polymers, metall oxides), hybrid capacitors (e.g. with asymmetric electrodes, lithium-ion capacitors, with composite electrodes), electrolytic capacitors (e.g. aluminium electrolytic capacitors), ceramic capacitors, mica capacitors, film capacitors, chip shape, lead shape capacitors, multilevel circuit board processed capacitors, etc.

As used in the claims and the specification, the term “phase change materials” shall refer to systems using a pure phase change material (PCM) substance and to systems using methods for increasing the thermal conductivity (e.g. inserted fins, heat pipes; added fillers, foams, particles, nanostructures; metal/semimetal/nonmetal materials; carbon, graphite, graphene, composites), and to systems using dispersed/decentralised/microcapsule packaging.

As used in the claims and the specification, the term “resonant frequency” shall refer to a fundamental frequency, harmonics, etc.

As used in the claims and the specification, the singular forms are intended to include the plural forms as well.

The term “to couple” and derivatives shall refer to a direct or indirect connection via another device and/or connection, such a connection can be mechanical, hydraulical, electrical, electronical, electromagnetical, pneumatical, communication, functional, etc., the term shall also refer to attach, detach, detachably attach, mount, connect, fix, join, support, link, bear, fasten, secure, tie, tether, chain, screw, weld, bond, solder, etc. Similarly as far as the term “coupling” concerned.

The terms, to “comprise”, “to include”, “to contain”, “to provide” and derivatives specify the presence of an element, but do not preclude the presence or addition of one or more other elements or groups and combinations thereof.

The term “consisting of” characterises a Markush group which is by nature closed. Single members of the group are alternatively useable for the purpose of the invention. Therefore, a singular if used in the Markush group would indicate only one member of the group to be used. For that reason are the countable members listed in the plural. That means together with qualifying language after the group “or combinations thereof” that only one member of the Markush group can be chosen or any combination of the listed members in any numbers. In other words, although elements in the Markush groups may be described in the plural, the singular is contemplated as well. Furthermore, the phrase, “at least one” preceding the Markush groups is to be interpreted that the group does not exclude one or more additional elements preceded by the phrase.

The invention will be described in reference to the accompanying drawings.

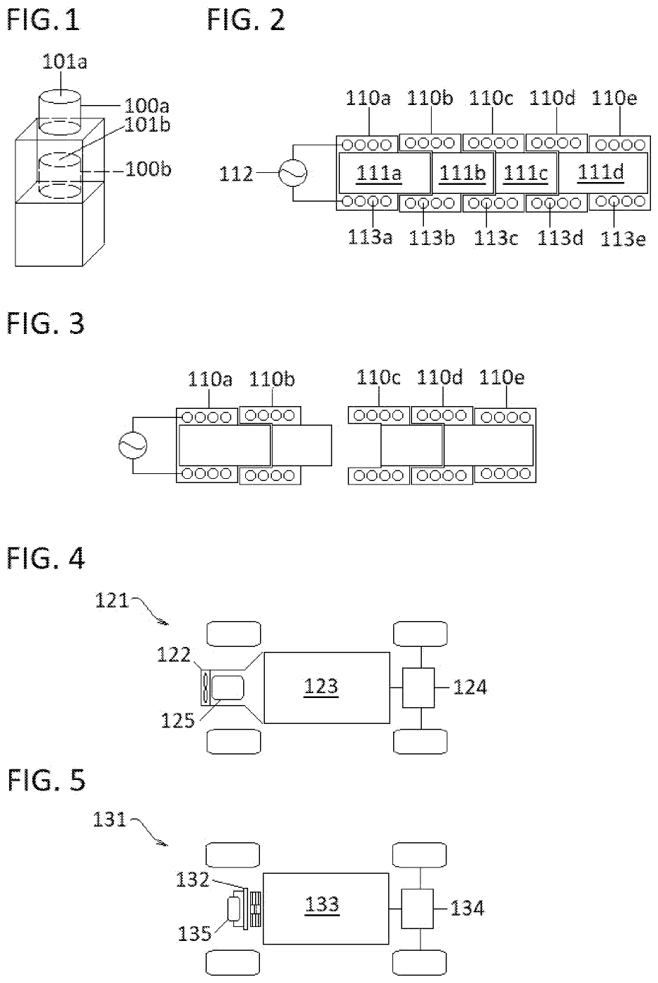

FIG. 1 is an oblique view of two electromagnetic heating coils (100a, 100b) with coil cores (101a, 101b) electromagnetically coupled.

FIG. 2 is a cross sectional view of five electromagnetic heating coils (110a, 110b, 110c, 110d, 110e) with the first coil (110a) coupled with a source of an alternating current (112). The coils (110a, 110b, 110c, 110d, 110e) can comprise coil cores (111a, 111b, 111c, 111d) and can be electromagnetically coupled. [The alternating current can produce heat in a respective coil winding (113a, 113b, 113c, 113d, 113e). The amount of produced heat can decrease from the coil (110a) through the coils (110b, 110c, 110d) to the coil 110e.]FIG. 3 is a cross sectional view of the system shown in FIG. 2 wherein the coils (110a, 110b, 110c, 110d, 110e) can be arranged to vary produced electromagnetic coupling and produced heat [e.g. can be movably arranged; any pair of adjacent coils (110a, 110b, 110c, 110d, 110e) can be electromagnetically decoupled, thus a produced heat regulation can be obtained]. The shown components can have different forms and shapes [e.g. can be spiral, planar, corrugated; various types of coil cores can be provided such as E, I, U, H cores; various types of coil backing plates and shielding can be provided such as round, squared, chamfered, etc.; various winding types can be provided within separate heating units containing the coils (110a, 110b, 110c, 110d, 110e) such as in series, in parallel, combined

FIG. 4 is a schematic plan view of an embodiment of an air cooled electromagnetic heating system for heating an electric vehicle (121) comprising a heating system (122) [which can include a fan, various processing units including a central processing unit, sensors and actuators, conduits and hoses, etc.], and a rechargeable power source (123) [which can be a battery pack, a battery capacitor hybrid pack, etc. and which can include thermal management system, source management system, etc.] powering an electric motor (124) [which can be any type of an electric motor configured to drive the wheels, and which can be an in-wheel motor, can be alternatively situated in front of the car, in the middle, etc.]. The electric vehicle (121) can comprise an electromagnetic heating system (125) (EHS) which can provide a car heating system with a limited number of components.

FIG. 5 is a schematic plan view of an embodiment of a liquid cooled electromagnetic heating system for heating an electric vehicle (131) comprising a heating system (132) [which can include a heat exchanger, a pump, a thermostat, a fan with a fan motor and a resistor, a switch, a fusebox, a heating system of conduits, a ventilation system, a climatisation system, etc.] and a rechargeable power source (133) powering an electric motor (134). The electric vehicle (131) can comprise an electromagnetic heating system (135) producing heat to heat the electric vehicle (131).

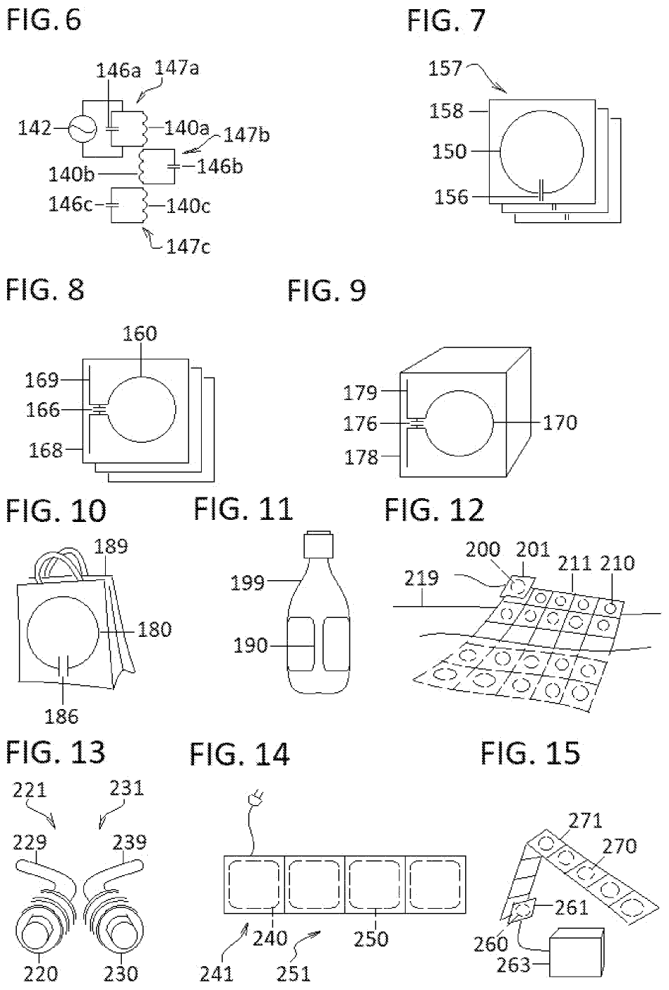

FIG. 6 is a diagram of an embodiment of three electromagnetic heating coils (140a, 140b, 140c) coupled in parallel (or in series) with three capacitors (146a, 146b, 146c) to form LC oscillators (147a, 147b, 147c) producing heat [which can be transferred by induction, radiation, convection to a heating or cooling medium/e.g. air, liquid, etc. with the first coil (140a) coupled with a source of an alternating current (142) [which can be a high frequency alternating current].

FIG. 7 is a schematic oblique view of another embodiment of heating oscillators which can comprise a heating coil (150) [which can have one or more turns, and which can be from a litz wire, from a hollow profil, from a full conductor, stranded round wires, a printed circuit board, etc.] with a capacitor (156) forming a LC oscillator (157) which can be encapsuled in an envelope (158) [which can be from a convenient heat conductive and resistant polymer which can be flexible and which can contain phase change material and which an electrically insulate electrocomponents, etc.] Any of sachets (158) can be removed to produce heat elsewhere distantly from the system without substantial impact on the functionality of the system [i.e. the remaining envelopes can continue to develop and eventually accumulate heat]. The system can be coupled with a programmable processing unit with memory, a controller, a sensor [e.g. the system can be coupled with body temperature sensors and can execute a preprogrammed routine of heating a patient's body, an animal body, etc.].

FIG. 8 is a schematic oblique view of another embodiment of heating oscillators which can comprise a heating coil (160) with a capacitor (166) providing a shunt and coupled with an antenna (169) [which can be a dipole antenna or any other type, e.g. a monopole antenna, a helix antenna, a loop antenna; an aperture antenna, e.g. a horn antenna; a reflector antenna, e.g. a parabolic antenna, a corner antenna; a lens antenna, e.g. a convex-plane, concave-plane, convex-convex, concave-concave; a micro strip antenna, e.g. circular shaped, rectangular shaped, metallic patch above ground plane; an array antenna, e.g. an Yagi Uda antenna, a micro strip patch array antenna, an aperture array antenna, a slotted wave guide array antenna] which can be encapsuled in an envelope (168).

FIG. 9 is a schematic oblique view of another embodiment of a heating oscillator which can comprise a heating coil (170) with a capacitor (176) providing a shunt and coupled with an antenna (179) which can be provided at a box (178) [which can be a transport box from various materials inclusive of polymers, thermic insulants, glass, metals, metal alloys, papers, cardboards, wood, etc.; the box can be intended to contain food, drinks, medicaments, chemicals, animals, plants, etc.].

FIG. 10 is a schematic perspective view of another embodiment of a heating oscillator which can comprise a heating coil (180) with a capacitor (186) which can be provided at a bag (189) [which can be a supermarket, restaurant, shopping bag from various materials, e.g. paper, plastics, cloths, etc. and which can include an insulation layer, e.g. sheet, pad, etc.]. The shown embodiment can be configured as a primary electromagnetic interface to heat and energize secondary electromagnetic interfaces (not shown) provided in the bag (189) or can be configured to be a secondary electromagnetic interface to be energized from a primary electromagnetic interface which can be provided in a bag holder, supporter, in a box, in a transporting mean, etc. [e.g. in a car, at home, at office, in a restaurant, etc.] or can be configured to be a transmitting (repeating) electromagnetic interface which can transmit energy from the primary to the secondary electromagnetic interface. The embodiment can be coupled or can contain a communication unit to communicate with an user's interface [e.g. a smartphone via a telephonic communication, with the Internet or the Internet of Things, etc.] so that an user (inclusive of an automated system) can remotely control the heating system, can set (time, heat) preferences, etc.

FIG. 11 is a schematic side view of another embodiment of a heating oscillator which can comprise a heating coil (190) at a bottle (199) [which can be a thermos, an insulated bottle from various materials such as metals, metal alloys, polymers, glass, etc.; the coil can be provided in different ways—can be glued in a sachet, can be provided in a coupled layer such as sheath, capsule, box, etc.]. An analogical system can be provided to heat drinks in other packaging [e.g. can, pouch, carton, etc.]. A primary electromagnetic interface (not shown) can be provided in a bottle holder, supporter, etc. [e.g. in a car, at home, at office, in a restaurant, etc.].

FIG. 12 is a schematic perspective view of another embodiment of an electromagnetic heating system which can comprise a primary electromagnetic interface (201) including one or more primary coils (200) and a secondary electromagnetic interface (211) including one or more secondary coils (210) wherein an inductive power transfer can be provided between the primary and the secondary electromagnetic interface wherein the secondary coils (210) can be configured to produce heat and the system can be configured to heat a pool (219) [inclusive of aquariums or any liquid containers, receptacles, tanks, etc.]. The secondary interface (211) can have secondary coils (210) wiredly and/or wirelessly interconnected to distribute power and the interface (211) can be configured to contain phase change materials accumulating heat, and can be configured to be partially buoyant [e.g. can at least partially include buoyant materials, air, be coupled with floats, etc.], can be insulated [e.g. against electrical, thermal, mechanical, water, moisture influences, etc.], can be modularly exchangeable and scallable [e.g. can be provided in different sizes, can provide electrically connecting devices [e.g. plugs and sockets, connectors, wireless interfaces, communication interfaces, etc.]. The system can be wiredly/wirelessly coupled with a sensing circuit [e.g. including a thermal sensor, a theft sensor, a motion sensor, a security sensor, etc.], the Internet [e.g. the system can be set to provide heating function according to the weather information received via the Internet, etc.].

FIG. 13 is a schematic perspective view of another embodiment of an electromagnetic heating system which can comprise a primary electromagnetic interface (221) including one or more primary coils (220) and a secondary electromagnetic interface (231) including one or more secondary coils (230) wherein an inductive power transfer can be provided between the primary and the secondary electromagnetic interfaces (221, 231) and wherein the primary and/or the secondary coils (220, 230) can be configured to produce heat [e.g. can be salient, provided with cooling fins, fibres, surface enlarging elements, nanostructures, etc.] and the system can be configured to heat conduits (229, 239) which can be provided with heat accumulation materials [e.g. can be provided in a masonry system, a ceilingy system, a floor system, etc.].

FIG. 14 is a schematic plan view of another embodiment of an electromagnetic heating system which can comprise a primary electromagnetic interface (241) [which can include a high frequency inverter, a frequency converter, etc.] including one or more primary coils (240) and a secondary electromagnetic interface (251) including one or more secondary coils (250) [which can be wiredly or wirelessly interconnected] wherein an inductive power transfer can be provided between the primary and the secondary electromagnetic interfaces (241, 251) and wherein the primary and/or the secondary coils (240, 250) can be configured to produce heat [e.g. can be flat provided with a heat reflective sheet, a thermal insulation backing, finned, etc.] and the system can be configured to heat a construction (not shown) [e.g. can be load resistant to heat sidewalk, watertight to heat a liquid tank, UV (ultra violet) resistant to heat a roof, shock resistant to heat an electric vehicle interior, etc.] and can be provided with a heat accumulation material [e.g. provided in a thermically insulated surrounding case, area, etc., within an earthen envelope, surrounded with sand, concrete, lime, cement, coal tar, gravel, or common earth, etc.]. The primary and/or the secondary interfaces (241, 251) can be flexible [e.g. the coils can be of litz wire, stranded wire; enveloping portions, an insulation, etc. and can be from flexible materials, etc.]

FIG. 15 is a schematic perspective view of another embodiment of an electromagnetic heating system which can comprise a primary electromagnetic interface (261) [which can be coupled with a home heating system (263) including or coupled with a (high) frequency inverter, converter, solar panels, wind turbine, a hydrogen fuel production unit, a hydrogen fuel storage unit, a processing unit, a controller, an user wired or wireless interface, the Internet, a wired/wireless communication interface and/or network, a fusebox, an Import/Export meter, a (smart) power grid, etc.] including one or more primary coils (260) and a secondary electromagnetic interface (271) including one or more secondary coils (270) [which can be wiredly or wirelessly interconnected] wherein an inductive power transfer can be provided between the primary and the secondary electromagnetic interfaces (261, 271) and wherein the primary and/or the secondary coils (260, 270) can be configured to produce heat [e.g. can be flat provided with a heat reflective sheet, a thermal insulation backing, etc.] and the system can be configured to heat a construction (not shown) [e.g. can be load resistant to heat, waterproof, load resistant, etc. to heat a roof, a roof window, a roof skylight, etc.] and can be provided with a heat accumulation material [e.g. provided in a thermically insulated surrounding case and can accumulate heat into roof tiles, etc.]. The primary and/or the secondary interfaces (261, 271) can be flexible, (predominantly) transparent, modularly scallable and exchangeable [e.g. to heat one or more roof parts, skylights, etc.] and (seasonally) removable, foldable, etc.

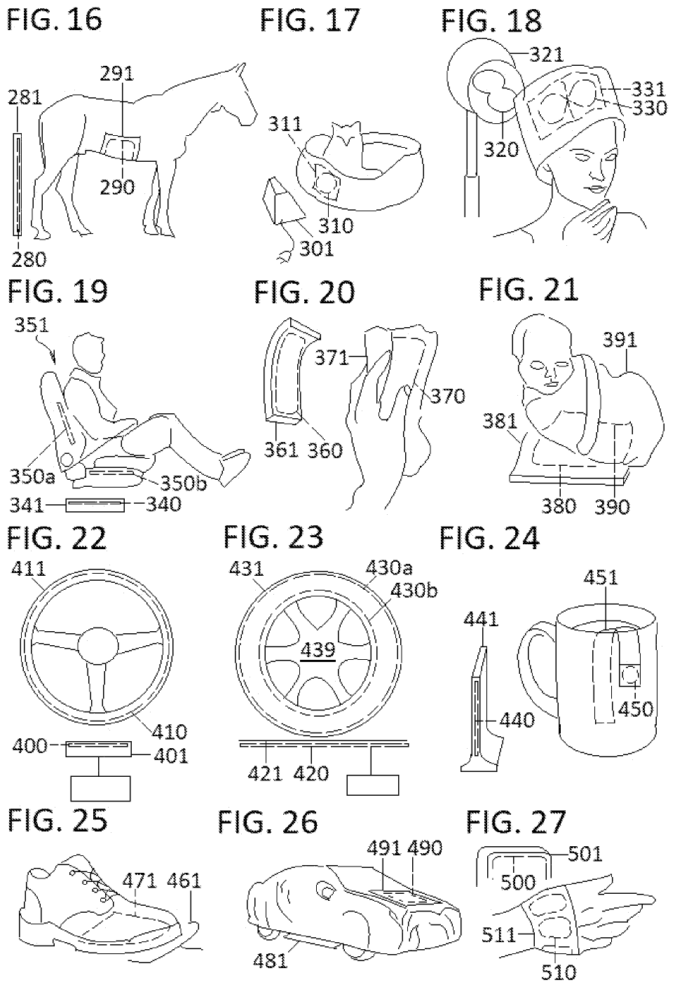

FIG. 16 is a schematic side view of another embodiment of an electromagnetic heating system which can comprise a primary electromagnetic interface (281) [which can be provided in a stable box, veterinary box, transporting trailer, etc.] including one or more primary coils (280) and a secondary electromagnetic interface (291) including one or more secondary coils (290) wherein a (resonant) inductive power transfer can be provided between the primary and the secondary electromagnetic interfaces (281, 291) and wherein the secondary coils (290) can be configured to produce heat [e.g. by means of clipping a flexible heating blanket as a winter coat which can be used in winter months for cooling down after a ride in a cold barn, and which can be provided from any part of the animal's body/e.g. from underside of the neck and abdomen to the sides of the horse, from the elbow to about a quarter of the way up the body, etc.]. The shown system can be analogically used for pets, dogs, cats, farm animals, sick animals, old animals, etc.

FIG. 17 is a schematic perspective view of another embodiment of an electromagnetic heating system which can comprise a primary electromagnetic interface (301) [which can be provided at home, at the vet, etc.] including one or more primary coils (not shown) and a secondary electromagnetic interface (311) including one or more secondary coils (310) wherein a (resonant) inductive power transfer can be provided between the primary and the secondary electromagnetic interfaces (301, 311) and wherein the secondary coils (310) can be configured to produce heat [e.g. by means of a coupled heating pad which can be used in cold periods, for older and sick animals, etc.].

FIG. 18 is a schematic perspective view of another embodiment of an electromagnetic heating system which can comprise a primary electromagnetic interface (321) [which can be provided in a hairdressing salon, at home, etc.] including one or more primary coils (320) [which can be crosswound coils] and a secondary electromagnetic interface (331) including one or more secondary coils (330) [which can be crosswound coils] wherein a (resonant) inductive power transfer can be provided between the primary and the secondary electromagnetic interfaces (321, 331) and wherein the secondary coils (330) can be configured to produce heat [e.g. by means of a coupled heating cap which can be used for hair drying, etc.].

FIG. 19 is a schematic perspective view of another embodiment of an electromagnetic heating system which can comprise a primary electromagnetic interface (341) [which can be provided in a car, at home, etc.] including one or more primary coils (340) [which can be a flat coupling coil] and a secondary electromagnetic interface (351) including one or more secondary coils (350a, 350b) [which can be wiredly or wirelessly interconnected or which can function independently] wherein a (resonant) inductive power transfer can be provided between the primary and the secondary electromagnetic interfaces (341, 351) and wherein the secondary coils (350a, 350b) can be configured to produce heat [e.g. by means of a heated seat and backrest, etc.].

FIG. 20 is a schematic perspective view of another embodiment of an electromagnetic heating system which can comprise a primary electromagnetic interface (361) [which can be provided in restaurant, in the kitchen, at home, etc.] including one or more primary coils (360) [which can be a three-dimensionally formed coupling coil] and a secondary electromagnetic interface (371) including one or more secondary coils (370) [which can be flexible coils/e.g. from litz wire, flexible conductive bands, etc. which can be insulated against moisture, load influences, etc.] wherein a (resonant) inductive power transfer can be provided between the primary and the secondary electromagnetic interfaces (361, 371) and wherein the secondary coils (370) can be configured to produce heat [e.g. by means of a heated towel, cloth, etc., which can be used in the kitchen, in the bathroom, in the stable, in the workshop, etc.]. Alternatively the secondary interface (371) can be provided in a heating pad, sheet, sheath, etc. to heat, dry up, warm up the cloth (not shown).

FIG. 21 is a schematic perspective view of another embodiment of an electromagnetic heating system which can comprise a primary electromagnetic interface (381) [which can be provided in the infirmary, in the maternity ward, at home, etc.] including one or more primary coils (380) [which can be sufficiently shielded an insulated] and a secondary electromagnetic interface (391) including one or more secondary coils (390) [which can be flexible shielded and insulated coils] wherein a (resonant) inductive power transfer can be provided between the primary and the secondary electromagnetic interfaces (381, 391) and wherein the secondary coils (390) can be configured to produce heat [e.g. by means of a swaddle, children's clothing, etc.]. The system can be provided with a controller, sensing circuits, position, electromagnetic, temperature sensors, etc., to provide a safe electromagnetic energy transfer and heat production.

FIG. 22 is a schematic front view of another embodiment of an electromagnetic heating system which can comprise a primary electromagnetic interface (401) [e.g. an electromagnetic heating car unit with a microcontroller coupled with a rechargeable power source] coupled with one or more primary coils (400) [which can be suitably directed, shielded an insulated] and a secondary electromagnetic interface (411) including one or more secondary coils (410) [which can be provided under a steering wheel coating, etc.] wherein a (resonant) inductive power transfer can be provided between the primary and the secondary electromagnetic interfaces (401, 411) and wherein the secondary coils (410) can be configured to produce heat [e.g. by means of the heat conducting steering wheel coating, etc.].

FIG. 23 is a schematic front view of another embodiment of an electromagnetic heating system which can comprise a primary electromagnetic interface (421) [e.g. a static/dynamic charging system provided in a track, road, sidewalk, etc.] coupled with one or more primary coils (420) [which can be at a same time charging coupling coils suitably shielded an insulated] and a secondary electromagnetic interface (431) including one or more secondary coils (430a) [which can be provided in a tire and which can function in charging/discharging mode and/or a heating mode, etc.] wherein a (resonant) inductive power transfer can be provided between the primary and the secondary electromagnetic interfaces (421, 431) and wherein the secondary coils (430a) can be configured to produce heat [e.g. by means of the heating tire, etc., which can be used in specific weather conditions of slippery ice, etc., and which can improve the tire adhesion]. The secondary coils (430b) can be provided in a wheel disc (439) in case of a provided transverse magnetic field as taught in my co-pending patent application titled “Electromagnetic power transfer system”.

FIG. 24 is a schematic perspective view of another embodiment of an electromagnetic heating system which can comprise a primary electromagnetic interface (441) [e.g. a portable or built-in electromagnetic heater, etc.] coupled with one or more primary coils (440) [which can be flat coils suitably three dimensionally formed] and a secondary electromagnetic interface (451) [which can be alternatively provided in a mug's (or another receptacle's) wall, bottom, ear, etc.] including one or more secondary coils (450) [which can be flat coils which can be fabricated by printed circuit boards techniques, encapsulated, glued, sealed, etc.] wherein a (resonant) inductive power transfer can be provided between the primary and the secondary electromagnetic interfaces (441, 451) and wherein the secondary coils (450) can be configured to produce heat [e.g. by means of a heating band which can be provided from various heat conductive materials such as metals, metal alloys, metal sheets, metal cloths, polymers, elastomers, heat conductive plastics/e.g. Acrylonitrile Butadiene Styrene (ABS), Polybutylene Terephthalate (PBT), polycarbonate, nylon, polypropylene, etc.].

FIG. 25 is a schematic perspective view of another embodiment of an electromagnetic heating system which can comprise a primary electromagnetic interface (461) [e.g. a portable electromagnetic heater, a built-in electromagnetic heater, etc.] coupled with one or more primary coils (not shown) [which can be flat coils] and a secondary electromagnetic interface (471) including one or more secondary coils (not shown) [which can be flat coils suitably wear protected] wherein a (resonant) inductive power transfer can be provided between the primary and the secondary electromagnetic interfaces (461, 471) and wherein the secondary coils (470) can be configured to produce heat [e.g. by means of a heating pad which can be incorporated into a shoe sole, which can be (detachably) attached or which can be inserted for a drying time, etc.]

FIG. 26 is a schematic perspective view of another embodiment of an electromagnetic heating system which can comprise a primary electromagnetic interface (481) [which can be provided in the garage, in the parking, at the charging station, etc., and which can be mobile or fixed] including one or more primary coils (not shown) [which can be, “O”, “8” flat coils] and a secondary electromagnetic interface (491) including one or more secondary coils (490) [which can be flat and flexible, “O”, “8” coils and which can be posed in any location] wherein a (resonant) inductive power transfer can be provided between the primary and the secondary electromagnetic interfaces (481, 491) and wherein the secondary coils (490) can be configured to produce heat [e.g. by means of a coupled heating car cover which can be used for drying after rain, garage moisture condensation to avoid a prolongated exposure of the car to the moisture, etc.].

FIG. 27 is a schematic perspective view of another embodiment of an electromagnetic heating system which can comprise a primary electromagnetic interface (501) [which can be provided in hospital, in the spa, at the trainer's, at home, etc.] including one or more primary coils (500) [which can be one or more flat coils] and a secondary electromagnetic interface (511) including one or more secondary coils (510) [which can be flat and flexible coils which can be wiredly or wirelessly interconnected] wherein a (resonant or non-resonant) inductive power transfer can be provided between the primary and the secondary electromagnetic interfaces (501, 511) and wherein the secondary coils (510) can be configured to produce heat [e.g. by means of a coupled heating band which can be magnetically conductive which can be used in magnetic heat therapy, etc.].

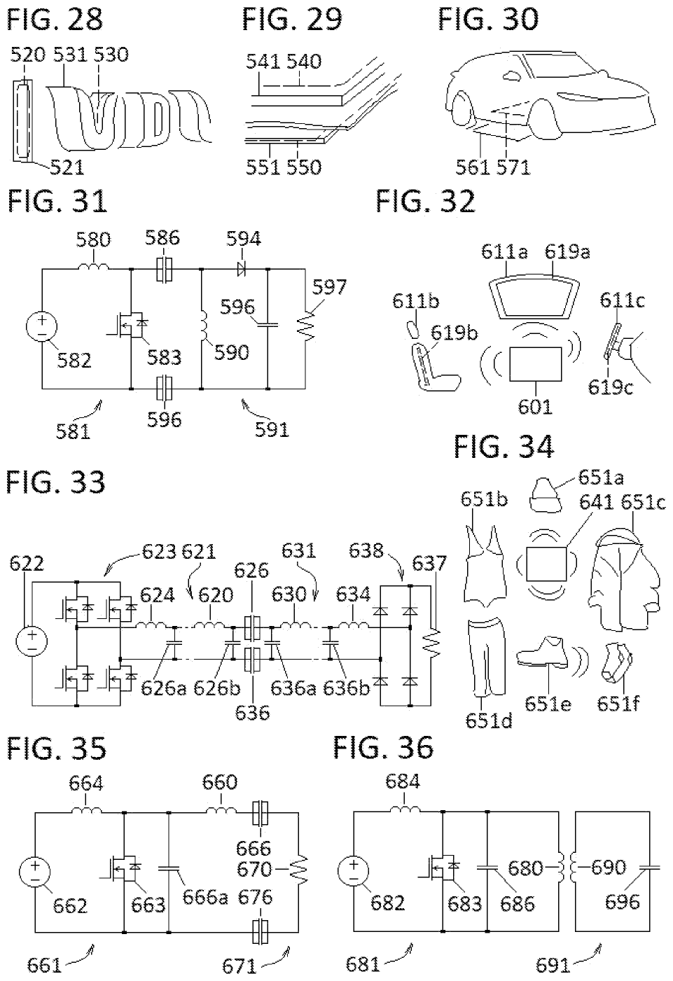

FIG. 28 is a schematic perspective view of another embodiment of an electromagnetic heating system which can comprise a primary electromagnetic interface (521) [which can be provided at an outdoor advertising, etc.] including one or more primary coils (520) [which can be a chain of flat coils] and a secondary electromagnetic interface (531) including one or more secondary coils (530) [which can be a chain of flat coils which can be crom a metallic wire, band or other flexible conductive path conductively interposed on an electrically conductive plastic producing heat] wherein a (resonant) inductive power transfer can be provided between the primary and the secondary electromagnetic interfaces (521, 531) and wherein the secondary coils (530) can be configured to produce heat [e.g. by means of a heating layer of the above described composition further comprising a heat reflecting sheet and a thermic insulation and which can be incorporated into the outdoor advertising mean such as lettres, panels, boards, screens, displays, etc., at any part of the entity which embodiment can artificially melt the snow, dry up moisture, etc. and keep the advertising mean clear and visible].

FIG. 29 is a schematic oblique view of another embodiment of an electromagnetic heating system which can comprise a primary electromagnetic interface (541) [which can be provided in a restoration workshop, etc.] including one or more primary coils (540) [which can be flat coils provided on a flat surface such as glass] and a secondary electromagnetic interface (551) including one or more secondary coils (550) [which can be flat flexible coils provided on a sheet type flexible substrate or in a flexible pouch, etc.] wherein a (resonant) inductive power transfer can be provided between the primary and the secondary electromagnetic interfaces (541, 551) and wherein the secondary coils (550) can be configured to produce heat [e.g. by means of a thermally conductive sheet which can be used for paper drying in a restoration workshop, fabric drying, cloth or clothes drying, etc.].

FIG. 30 is a schematic perspective view of another embodiment of an electromagnetic heating system which can comprise a primary electromagnetic interface (561) [which can be provided in the garage, in the parking, at the charging station, etc., and which can be mobile or fixed] including one or more primary coils (not shown) [which can be, “O”, “8” flat coils] and a secondary electromagnetic interface (571) including one or more secondary coils (not shown) [which can be flat and flexible, “O”, “8” coils and which can be posed in any location to heat the car/e.g. floor, seats, ceiling, rechargeable power source, heat accumulation elements, power electronics, etc.] wherein a (resonant or non-resonant) inductive, capacitive, magnetodynamic, electromagnetic power transfer can be provided between the primary and the secondary electromagnetic interfaces (561, 571) and wherein the secondary coils can be configured to produce heat [e.g. by means of a coupled heating car device such as heating carpet, upholstery, seat, ceiling layer which can contain a tuned circuit which can include a coil which can be conductively coupled with electrically conductive plastic forming a heating layer on a support which can be a flexible layer/e.g. from a fibrous nonwoven fabric with natural and/or synthetic fibres/]. The system can be provided as monofunctional or can be advantageously coupled with a home, office, public, etc., static and/or dynamic wireless (resonant, conductive, capacitive, magnetodynamic, electromagnetic) charging system. The system can be configured to preheat the car in cold periods in the garage, at the charging station, etc., simultaneously with charging/discharging the vehicle. The system can be programmed to cooperate with a charging station, with a battery management system of the car. Charging—heating preferences can be set, simultaneous charging and heating or successive charging/heating can be provided and so on. The system can communicate with vehicle controllers, the central vehicle controller, the vehicle control unit, the controller of the charger, etc.

FIG. 31 is a schematic diagram of another embodiment of an electromagnetic heating system which can comprise a primary electromagnetic interface (581) including a primary coil (580) and a secondary electromagnetic interface (591) including a secondary coil (590) wherein a (non-resonant) capacitive or electromagnetic power transfer can be provided between the primary and the secondary electromagnetic interfaces (581, 591) by means of capacitive or electromagnetic couplers (586, 596) and wherein the secondary coil (590) can be configured to produce heat. The shown embodiment in pulse width modulation (PWM) topology can include in the primary circuit a direct current (DC) power source (582), a switch (583) [which can be a Field Effect Transistor (FET) (with a shunt diode) with adequate voltage and current ratings driven by a control circuit (not shown) and which can be monitored by sensors for sensing voltage and current (not shown), etc.]. The secondary circuit can include a diode (594), a capacitor (596) and a load (597) [e.g. a layer producing electrical resistance heating]. Other PWM topologies than the sepic converter can be advantageously used for short distance applications [e.g. Buck-boost, Cuk, Zeta, etc].

FIG. 32 is a schematic perspective view of another embodiment of an electromagnetic heating system which can comprise a primary electromagnetic interface (601) [which can be provided in a vehicle (or vessel) interior] including one or more primary coils (not shown) and a secondary electromagnetic interfaces (611a, 611b, 611c) including one or more secondary coils (not shown) wherein a (resonant) inductive, capacitive, electromagnetic and/or magnetodynamic power transfer can be provided between the primary and the secondary electromagnetic interfaces (601, 611) and wherein the secondary coils can be configured to produce heat [e.g. by means of a heating sheet (619a) which can be transparent, a heating layered construction on a flexible substrate (619b) and of a flexible coated heating band (619c)]. Each secondary electromagnetic interface (611a, 611b, 611c) can use a different resonant and/or harmonic frequency. The system can be configured so that the primary electromagnetic interface can choose which of the secondary electromagnetic interfaces (611a, 611b, 611c) can be provided with power using the different resonant and/or harmonic frequencies.

FIG. 33 is a schematic diagram of another embodiment of an electromagnetic heating system which can comprise a primary electromagnetic interface (621) including a primary coil (620) and a secondary electromagnetic interface (631) including a secondary coil (630) wherein a (resonant) capacitive or electromagnetic power transfer can be provided between the primary and the secondary electromagnetic interfaces (621, 631) by means of capacitive or electromagnetic couplers (626, 636) and wherein the secondary coil (630) can be configured to produce heat. The shown embodiment in full-bridge inverter topology and a multiple LCLC compensation [which can be symmetrical or asymmetrical and wherein number of LC cells can be varied in according to the system requirements] can include in the primary circuit an inverter (623) a DC power source (622), an inductor (624), a capacitor (626a), the primary coil (620) and a capacitor (626b). A secondary circuit can include a capacitor (636a), the secondary coil (630), a capacitor (636b), an inductor (634), a rectifier (638) and a load (637) [which can be an electrical resistance heating circuit]. The primary and the secondary coils (620) and (630) can be inductively coupled in a combined energy transfer system (inductive, capacitive or electromagnetic). [The coils and inductors (620, 624) and (630 and 634) can be used to increase voltage for sufficient power transfer and can resonate in multiple resonances with the capacitors (626a and 626b) and (636a and 636b) and with the electromagnetic or capacitive couplers (626, 636). The capacitors (626a, 636a) can reduce the primary and the secondary coils (620, 630). The system power can be proportional to a coupling coefficient and can be regulated through circuit parameter design (e.g. through the capacitors (626a, 636b).] Other full-bridge inverter topologies and compensations can be used.

FIG. 34 is a schematic perspective view of another embodiment of an electromagnetic heating system which can comprise a primary electromagnetic interface (641) [which can be provided at home, in the sports complex, in the laundry, etc.] including one or more primary coils (not shown) and secondary electromagnetic interfaces (651a, 651b, 651c, 651d, 651e, 651f) including one or more secondary coils (not shown) wherein a (resonant) inductive, capacitive, electromagnetic and/or magnetodynamic power transfer can be provided between the primary and the secondary electromagnetic interfaces (641, 651a, 651b, 651c, 651d, 651e, 651f) and wherein the secondary coils can be configured to produce heat. The secondary electromagnetic interface (651e) can function as a repeating interface to provide wirelessly energy for the secondary electromagnetic interface (651f). The shown embodiment can be provided for static applications and for dynamic applications [e.g. the primary interface (641) can be provided in a vehicle or water vessel and/or can be portable and provided at an user and the secondary interfaces (641, 651a, 651b, 651c, 651d, 651e, 651f) can be weared by the user which can dry his clothes while wearing them which can be used during sports, camping, in everyday life. The primary interface (641) can be coupled or can contain a rechargeable power source and/or a power generator [e.g. vehicle's battery, solar panel, portable battery, fuel cell, etc.].

FIG. 35 is a schematic diagram of another embodiment of an electromagnetic heating system which can comprise a primary electromagnetic interface (661) including a primary coil (660) and a secondary electromagnetic interface (671) including a secondary coil (670) wherein a (resonant) capacitive or electromagnetic power transfer can be provided between the primary and the secondary electromagnetic interfaces (661, 671) by means of capacitive or electromagnetic couplers (666, 676) and the secondary coil (670) can be configured to produce heat. The shown embodiment in a power amplifier topology can include in the primary circuit a DC power source (662), an inductor (664), a switch (663) [a switching frequency can be increased to a very high value which can reduce a size of passive components], a capacitor (666a) and the primary coil (660). A secondary circuit can include a load [which can be the secondary heating coil (670)]. Other high frequency power amplified topologies than the class E converter can be used for increased energy transfer distance [e.g. class D, class EF, etc.].

FIG. 36 is a schematic diagram of another embodiment of an electromagnetic heating system which can comprise a primary electromagnetic interface (681) including a primary coil (680) and a secondary electromagnetic interface (691) including a secondary coil (690) wherein a (resonant) inductive power transfer can be provided between the primary and the secondary electromagnetic interfaces (681, 691) by means of (resonant) inductive couplers (680, 690) and the secondary coil (690) can be configured to produce heat. The shown embodiment in a power amplifier topology can include in the primary circuit a DC power source (682), an inductor (684), a switch (683) [a switching frequency can be increased to a very high value which can reduce a size of passive components], a capacitor (686) and the primary coil (680). A secondary circuit can include a load [which can be the secondary heating coil (690)] and a capacitor (696). Other high frequency power amplified topologies can be used for increased energy transfer distance.

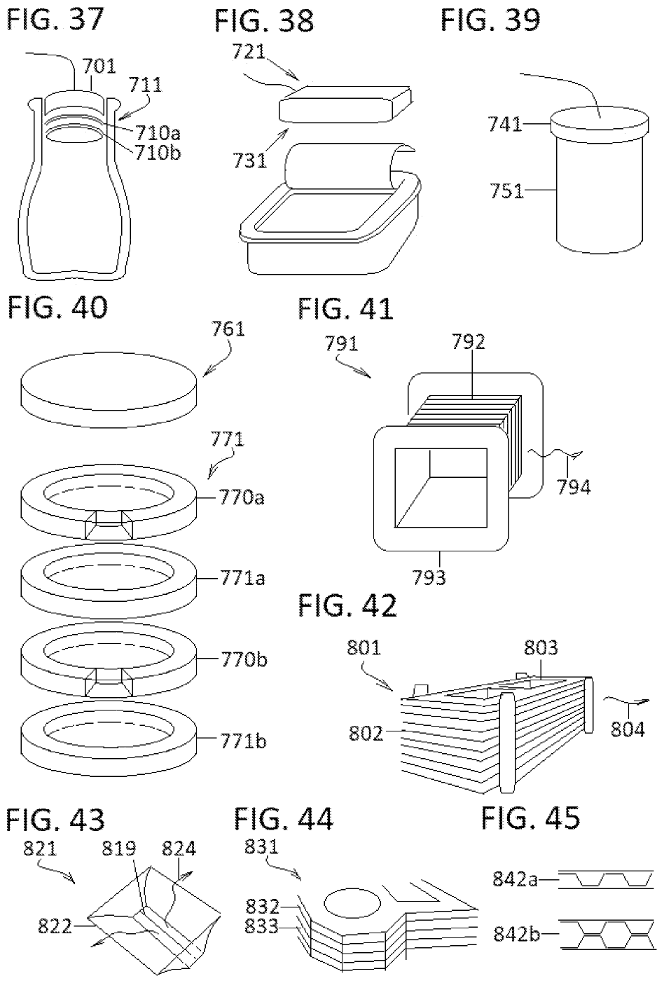

FIG. 37 is a schematic perspective view of another embodiment of an electromagnetic heating system which can comprise a primary electromagnetic interface (701) [which can be provided in a compact encapsulated and insulated form which can include a microcontroller in a form of a chip] including one or more primary coils (not shown) [which can be a flat coupling coil provided on a lower surface] and a secondary electromagnetic interface (711) including one or more secondary coils (710a, 710b) [which can be flat coils which can be wiredly or wirelessly interconnected and provided between layers of a magnetically conductive material.] wherein a (resonant or non-resonant) inductive power transfer can be provided between the primary and the secondary electromagnetic interfaces (701, 711) and wherein the secondary coils (710a, 710b) can be configured to produce heat [e.g. by means of a thermally conductive plug material, etc.]. [The layered construction of the secondary electromagnetic interface (711) can be composed predominantly of alternating layers of the coils (710a, 710b) and magnetic conductors which can be at the same time good heat conductors [e.g. some ferrites, polymers, metals, etc.] The system can be applied to heat the drink.

FIG. 38 is a schematic perspective view of another embodiment of an electromagnetic heating system which can comprise a primary electromagnetic interface (721) [which can be provided in a compact encapsulated and insulated form which can include a microcontroller in a form of a chip] including one or more primary coils (not shown) [which can be a flat coupling coil] and a secondary electromagnetic interface (731) including one or more secondary coils (not shown) [which can be flat coils which can be wiredly or wirelessly interconnected and provided between layers of a magnetically conductive material.] The system can be applied to warm up food.

FIG. 39 is a schematic perspective view of another embodiment of an electromagnetic heating system which can comprise a primary electromagnetic interface (741) and a secondary electromagnetic interface (751) in a compact packaging.

FIG. 40 is a schematic exploded perspective view of another embodiment of an electromagnetic heating system which can comprise a primary electromagnetic interface (761) [which can be provided in a compact electromagnetically shielded form/e.g. by an external cylindric thermally conductive metallic sheet/and which can include an electron discharge device which can include a high tension transformer, a filament heating transformer/either of which can include a primary coil/and conductors to the terminal of the tube or a magnetron which can create the oscillation by the physical shape of the anode constituting an inductance and a capacitance which together with the capacitance between the anode and the cathode can be tuned to a resonant frequency by methods known in the art and which can produce microwaves; a magnetic field parallel to the cathode can be produced by a an external coil or by a permanent magnet; the microwaves can be emitted by an antenna and conducted by a waveguide, alternatively a microwave semiconductor oscillator can be used to produce microwaves]. A secondary electromagnetic interface (771) can include one or more secondary coils (770a, 770b) [which can be one turn coils from a good conductor such as aluminium or copper constituting and inductance and a capacitance by the physical shape and tuned to the resonant frequency or harmonic microwave frequency of the system; the inductance and capacitance can be tuned by dimensions, shapes and forms of the oscillator; e.g. metallic discs can be provided at both ends of the coils (770a, 770b) (not shown)]. The secondary coils (770a, 770b) can be configured to produce heat [e.g. by means of fins, sinks, or other shapes and forms provided in a thermal contact with the coils (770a, 770b), etc.; the heat sinks can go beyond the outline of the coils (770a, 770b); the coils can be divided by spacers (771a, 771b)]. The primary and the secondary interfaces (761, 771) may not have exactly the same resonant or harmonic frequency.

FIG. 41 is a functional perspective illustration of an apparatus which can provide the proposed microwave heating method for a heating system comprising a primary electromagnetic interface (not shown) including a microwave energy generator and a secondary electromagnetic interface (791) including one or more heat sinks (792), the method characterised in that it can comprise: the step of providing the microwave energy by means of the microwave energy generator; the step of conducting the microwave energy to the one or more heat sinks [e.g. by means of a waveguide (793); the step of transforming electromagnetic wave into heat [e.g. by means of heat radiation (794)]. The heat sinks (792) can be configured to have substantially the same resonant frequency or a harmonic frequency as the primary electromagnetic interface [e.g. providing inductance and capacitance].

FIG. 42 is a functional perspective illustration of another apparatus which can provide the proposed microwave heating method for a heating system comprising a primary electromagnetic interface (not shown) including a microwave energy generator and a secondary electromagnetic interface (801) including one or more heat sinks (802) thermally coupled with waveguides (803) and producing electromagnetically induced heat by means of heat radiation (804).

FIG. 43 is a functional perspective illustration of another apparatus which can provide the proposed microwave heating method for a heating system comprising a primary electromagnetic interface (not shown) including a microwave energy generator which can include an antenna (819) [which can emitte thermo-electrons] and a secondary electromagnetic interface (821) including one or more heat sinks (822) [which can be horn formed] radiating heat (824). [Transverse magnetic field, transverse electric field and transverse electromagnetic field horn antennas may be used. Conductive plates can have monotonically, exponentially increasing plates or others, and separation angles can be constant, monotonically, exponentially increasing. The conductive plates can have planar cross-section or can have convex cross-section or others. The conductive plates can be provided with strips, sheets or other shapes of resistive loading material/e.g. from a lossy microwave material such as ferrite- or carbon-particle loaded materials/]

FIG. 44 is a functional partial perspective illustration of another apparatus which can provide the proposed microwave heating method for a heating system comprising a primary electromagnetic interface (not shown) including a microwave energy generator and a secondary electromagnetic interface (831) including one or more heat sinks (832) [which can have irregular shapes] and air gaps (833).

FIG. 45 is a cross sectional view of examples of heat sinks (842a, 842b) shapes which can be used in the present invention.

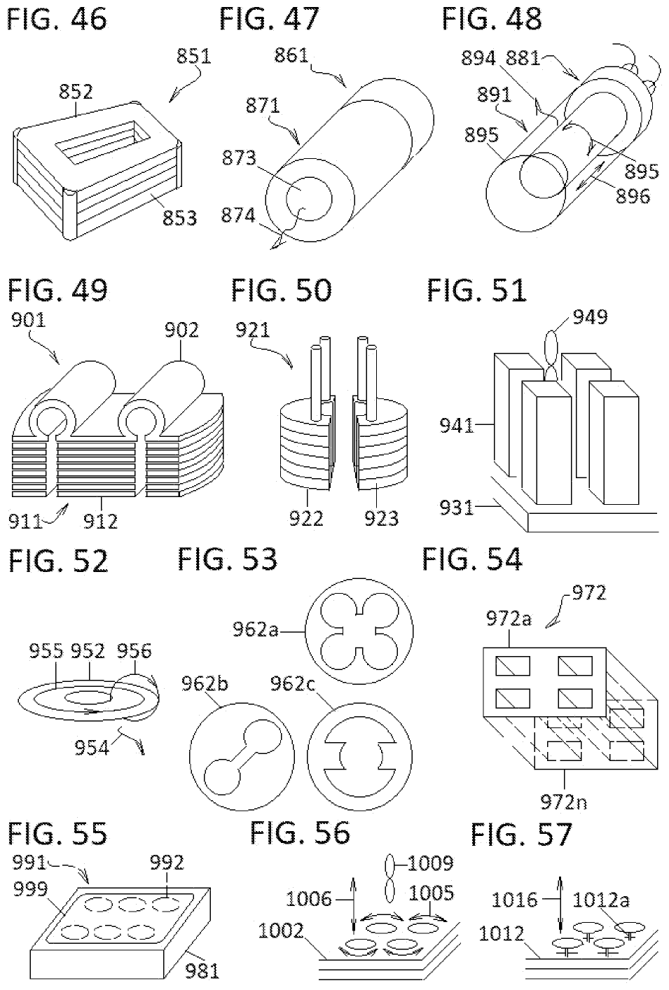

FIG. 46 is a functional perspective illustration of another apparatus which can provide the proposed microwave heating method for a heating system comprising a primary electromagnetic interface (not shown) including a microwave energy generator and a secondary electromagnetic interface (851) including one or more heat sinks (852) [which can have irregular shapes] and air gaps (853).

FIG. 47 is a functional oblique view of another apparatus which can provide the proposed microwave heating method for a heating system comprising a primary electromagnetic interface (861) including a microwave energy generator and a secondary electromagnetic interface (871) including one or more heat sinks (not shown) [which can be directed towards an interior hole (873)] radiating heat (874).

FIG. 48 is a functional oblique view of another apparatus which can provide the proposed microwave heating method for a heating system comprising a primary electromagnetic interface (881) including a microwave energy generator [which can include a magnetron or an electron discharge device which can include or can be coupled with a high tension transformer and with a heating transformer/which can have a common laminated core, conductors to the terminals and filters; and which can further include a control unit, a thermostat, electromagnets or permanent magnets, a housing wherein a part with the electron discharge device or the magnetron can be hermetically sealed, a control interface, etc.] and a secondary electromagnetic interface (891) including one or more heat sinks (not shown) [which can be substantially parallel oriented electromagnetic heat sinks which can be coupled by a very high frequency magnetic field (896) producing an oscillating electric current (895) directed perpendicularly to the magnetic field and having substantially the same or harmonic frequency as the microwave energy generator] radiating heat. The primary and the secondary interfaces (881, 891) can be electromagnetically shielded (897) [e.g. by noise removers in forms of choke structures for restriction of harmonic noise, by means of one or more thin surrounding layers provided in calculated thickness and distances to reduce harmonics, etc.; outer layers can further radiate heat (894); a heating cartridge can thus be provided].

FIG. 49 is a schematic perspective illustration of another apparatus which can provide the proposed microwave heating method for a heating system comprising a primary electromagnetic interface (901) including a microwave energy generator [schematically shown orientation of an anode (902) which can include a heated cathode] and a secondary electromagnetic interface (911) including one or more heat sinks (912) [which can be parallel oriented] radiating heat.

FIG. 50 is a functional perspective illustration of another apparatus which can provide the proposed microwave heating method for a heating system comprising a primary electromagnetic interface (not shown) including a microwave energy generator and a secondary electromagnetic interface (921) including one or more heat sinks (922) [which can have round shapes] and air gaps (923).

FIG. 51 is a functional perspective illustration of another apparatus which can provide the proposed microwave heating method for a heating system comprising a primary electromagnetic interface (931) including a microwave energy generator and a secondary electromagnetic interface (941) including one or more heat sinks with air gaps (not shown) and an air flow mean (949) [e.g. a transversal flow fan].

FIG. 52 is a functional perspective illustration of an electromagnetic heat sink (952) which can be used in an apparatus which can provide the proposed microwave heating method for a heating system. The heat sink (952) can be energized by a microwave energy wherein an induced (oscillating) electrical current (955) produces an (oscillating) magnetic field (956) [which can form a rotating annulus magnetic field]. Microwave energy can produce heat energy (954).

FIG. 53 are plan views of resonant electromagnetic heat sinks (962a, 962b, 962c) which can be used in an apparatus which can provide the proposed microwave heating method for a heating system. The heat sinks (962a, 962b, 962c) can provide inductance and capacitance and can be tuned to the same or substantially the same resonant frequency as a primary electromagnetic interface [inclusive of harmonics]. Microwave energy can produce heat energy.

FIG. 54 is a schematic oblique view of an electromagnetic heat sink block (972) which can be used in an apparatus which can provide the proposed microwave heating method for a heating system. The heat sink block (972) can be composed of a plurality of heat sinks (972a to 972n) (only end sinks shown) which can be energized by a microwave energy which can produce heat energy (974).

FIG. 55 is a schematic oblique view of another apparatus which can provide the proposed microwave heating method for a heating system comprising a primary electromagnetic interface (981) including a microwave energy generator [which can include a magnetron or an electron discharge device, electromagnets or permanent magnets, a controller, a thermal control unit with a thermostat, a security control device, a housing wherein a part with the electron discharge device or the magnetron can be hermetically sealed, a communication interface which can be a control panel, a wired or wireless interface, a liquid crystal display, manual or electrical controllers, an input/output controlling device, etc., a fan, an electromagnetic shielding of the electronic component, a high-voltage transformer preferably with primary and secondary coils and a laminated core, a high voltage condenser, a high voltage diode constituting a drive module operating the magnetron or the electron discharge device and a secondary electromagnetic interface (991) including one or more heat sinks (992) (not shown) [which can be parallel oriented] radiating heat which can heat a plate (999) [e.g. a cooking plate].

FIG. 56 is a partial functional oblique view of an electromagnetic heat sinks blok which can be used in an apparatus which can provide the proposed microwave heating method for a heating system. The heat sinks (1002) can be energized by a microwave energy providing an oscillating magnetic field (1006) inducing oscillating electric eddy currents (1005) which can produce an induction heating effect wherein FR losses of the material resistivity can cause heat to be created. Heat dissipation can be supported by a fan (1009) or other means. The heat sinks (1002) can be interconnected by electromagnetically conductive structures (not shown). Spacers, insulation, shielding can be further provided (not shown).

FIG. 57 is a partial functional oblique view of electromagnetic conductor layers (1012) [which can be magnetically interconnected and activated by a substantially perpendicular high frequency oscillating primary magnetic field (1016) [which can be produced by a primary electromagnetic interface (not shown)] which can accordingly to the Faraday's law of electromagnetic induction induce currents in the conductor layers (1012) [e.g. eddy currents] wherein induced eddy currents can induce other eddy currents which can circulate in the same direction in the conductor layers in places where eddy currents are not directly induced by the primary magnetic field thus microwave energy can be distributed in a direction perpendicular to the primary magnetic field (1016) by means of electrically conductive layers. The shown microwave energy conducting layers (1012) can be used in an apparatus which can provide the proposed microwave heating method for a heating system, mainly in the second step of conducting the microwave energy to one or more heat sinks (1012) which can in the third step of transforming electromagnetic wave into heat [e.g. by means of the heat sinks (1012) which can perform the both steps and which can be further configured to have the same or substantially the same resonant frequency as the primary electromagnetic interface [e.g. can include an internal structure (1012a)/which can be slots, joints, windows, etc. which can provide inductance and capacitance]. The heat conductor layers (1012) can be composed of various separated portions which can be tuned to the same or substantially the same resonant frequency as a primary electromagnetic interface.

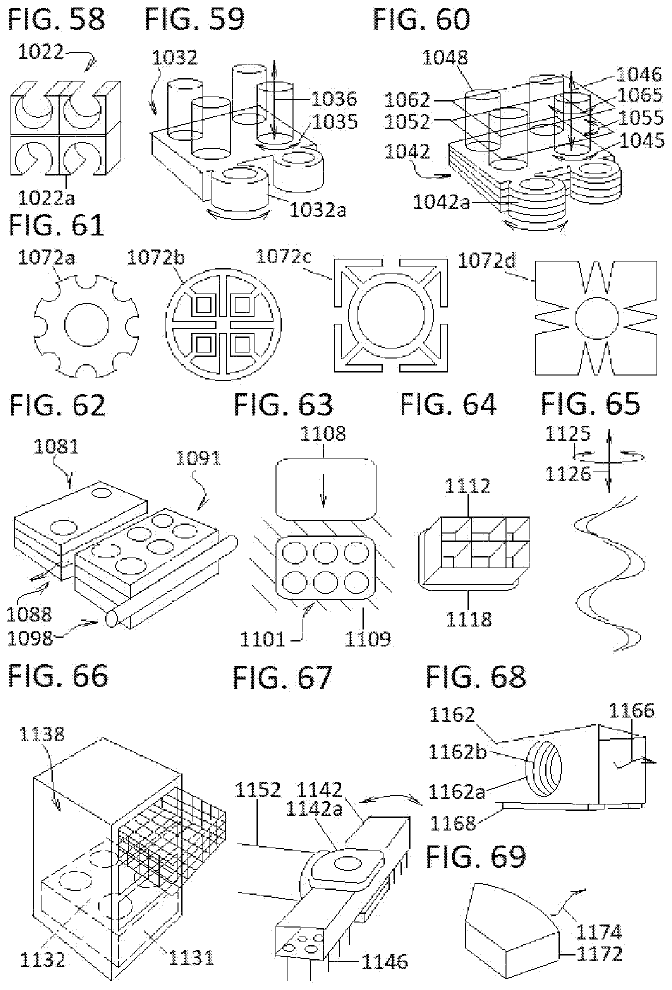

FIG. 58 is a partial functional oblique view of an electromagnetic conductor layer (1022) which can be configured to have the same or substantially the same resonant frequency as a primary electromagnetic interface [e.g. can be composed of various separated portions (1022a) which can be tuned to the same or substantially the same resonant frequency as the primary electromagnetic interface].

FIG. 59 is a partial functional oblique view of an electromagnetic conductor layer (1032) [which can be hollow and which can provide one or more connecting points (1032a)] which can be coupled with a microwave energy generator (not shown) providing a microwave energy [e.g. by means of magnetrons] in the first step of the proposed method wherein the conductor layer (1032) can conduct the microwave energy to heat sinks (not shown) [e.g. by means of induced eddy currents (1035) in a same layer and by means of a magnetic field (1036) between the (parallel) layers (not shown) which can be conductor layers conducting the microwave energy and transforming electromagnetic waves into heat].

FIG. 60 is a partial functional oblique view of electromagnetic conductor layers (1042) [which provide one or more layered connecting points (1042a) which can be coupled with a microwave energy generator (not shown) providing a microwave energy in the first step of the proposed method wherein the conductor layers (1042) can conduct the microwave energy to heat sinks (1052, 1062) [e.g. by means of induced eddy currents (1045, 1055, 1065) in a same layer and by means of an electromagnetic field (1046) between the (parallel) layers (1042, 1052, 1062) which can be interconnected by connecting structures (1048)/e.g. electrical conductors, magnetic conductors, spacers, etc.) which can be provided across the layers (1042, 1052, 1062), around the perimeter, at the corners, etc.].

FIG. 61 are plan views of electromagnetic conductors (1072a, 1072b, 1072c, 1072d) which can be used in an apparatus which can provide the proposed microwave heating method for a heating system. The electromagnetic conductors (1072a, 1072b, 1072c, 1072d) can provide a conductive path for induced eddy currents, inductance and capacitance.

FIG. 62 is a functional perspective illustration of another apparatus which can provide the proposed microwave heating method for a heating system comprising a primary electromagnetic interface (not shown) including a microwave energy generator providing a microwave energy and secondary electromagnetic interfaces (1081, 1091) including one or more electromagnetic conductors conducting the microwave energy and producing electromagnetically induced heat, for example by means of a gas heating system (1088) [which can further include sensors, controllers, external controls, processors, valves, fans, filters, etc.] and a liquid heating system (1098) [which can further include sensors, controllers, external controls, processors, valves, conduits, pumps, expansion tanks, etc.].

FIG. 63 is a plan view of another apparatus which can provide the proposed microwave heating method for a heating system comprising a primary electromagnetic interface (not shown) including a microwave energy generator providing a microwave energy and a secondary electromagnetic interface (1101) including one or more electromagnetic conductors conducting the microwave energy and transforming electromagnetic wave into heat. A cover (1108) can be provided (shown in a pushed aside position) [e.g. from metal, glass with metal screen, etc.]. The interface (1101) can be built in a ceramic insulation (1109) [or another lossy microwave material such as alumina, etc.].

FIG. 64 is an oblique view of a heating cover (1118) provided with heat sinks (1112) [which can have different shapes or forms] which can be used in the embodiment as shown in FIG. 63.

FIG. 65 is a functional schematic of the principle of the proposed method showing how the electromagnetic conductor can conduct the microwave energy by means of induced (eddy) currents (1125) in a same layer and by means of a high-frequency magnetic field (1126) between the (parallel) layers (not shown) which can be conductor layers and/or electromagnetic heat sinks.

FIG. 66 is a schematic oblique view of another apparatus which can provide the proposed microwave heating method for a heating system comprising a primary electromagnetic interface (not shown) including a microwave energy generator [which can include a magnetron and other electric elements for heating, a fan and a control panel and which can generate microwaves of 2450 MHz] and a secondary electromagnetic interface (1131) which can include one or more electromagnetic conductors (1132) transforming electromagnetic wave into heat which can be radiated in a chamber (1138) [e.g. a drying chamber, a cooking chamber, a furnace chamber, etc.].

FIG. 67 is a partial functional perspective illustration of an electromagnetic conductor (1142) [which can be hollow and which can provide one or more connecting points (1142a) which can be coupled with a microwave energy generator (not shown) providing a microwave energy in the first step of the proposed method wherein the conductor (1142) [which can be rotatably coupled] can conduct the microwave energy from a waveguide tube (1152) [e.g. in a transverse electric (TE) mode or a transverse magnetic (TM) mode]. Electromagnetically induced heat can be produced by radiating microwaves (1146).

FIG. 68 is a functional perspective view of an electromagnetic conductor (1162) [which can be hollow and which can include conductive layers (1162b) [which can be configured to be heat sinks] and which can provide one or more connecting points (1162a) which can be coupled with a microwave energy generator (not shown) providing a microwave energy in the first step of the proposed method wherein the conductor (1162) can conduct the microwave energy [e.g. in a transverse electromagnetic (TEM) mode]. Electromagnetically induced heat can be produced by radiating microwaves (1166). Resistive loading (1168) can be added to the exterior (or interior) surfaces to attenuate or inhibit surface currents thus managing the microwave energy transfer and a heating performance.

FIG. 69 is a perspective view of an electromagnetic conductor (1172) [which can be a horn antenna] which can be coupled with a microwave energy generator (not shown) providing a microwave energy in the first step of the proposed method wherein the conductor (1172) can conduct the microwave energy [e.g. in TE, TM, TEM modes]. Electromagnetically induced heat (1174) can be produced by the induction heated horn antenna (1172).

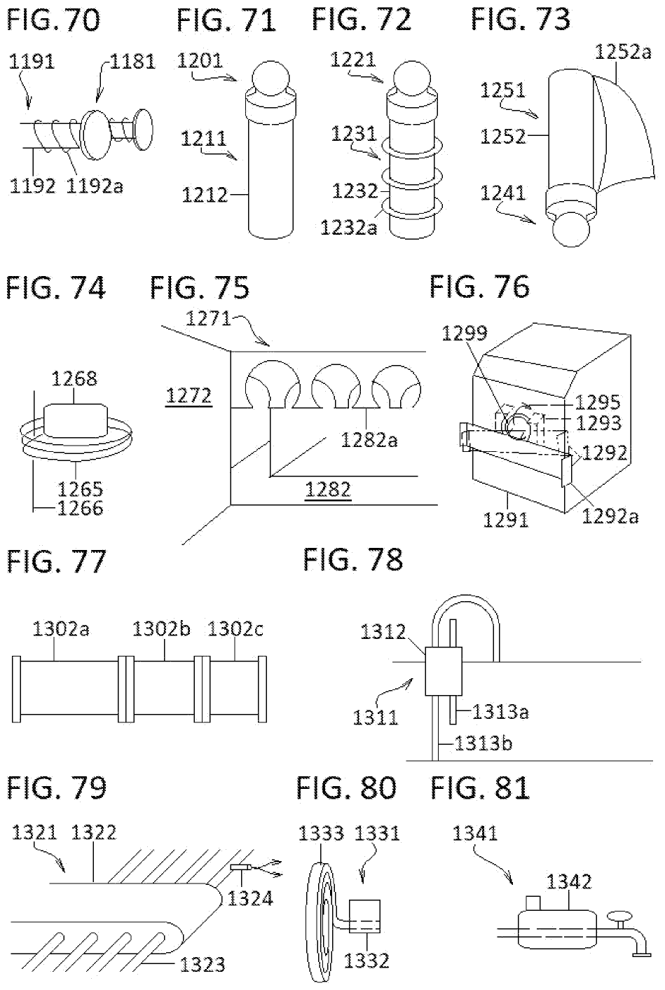

FIG. 70 is a schematic perspective view of another apparatus which can provide the proposed microwave heating method for a heating system comprising a primary electromagnetic interface (1181) including a microwave energy generator [which can generate microwaves of 2450 MHz] and a secondary electromagnetic interface (1191) which can include one or more electromagnetic conductors (1192) transforming electromagnetic wave into heat which can be radiated by means of heat sinks (1192a).

FIG. 71 is a schematic perspective view of another apparatus which can provide the proposed microwave heating method for a heating system comprising a primary electromagnetic interface (1201) including a microwave energy generator [which can generate microwaves in transverse electric (TE) mode, transverse magnetic (TM) mode or transverse electromagnetic (TEM) mode] and a secondary electromagnetic interface (1211) which can include one or more electromagnetic conductors (1212) transforming electromagnetic wave into heat.

FIG. 72 is a variant of the embodiment shown in FIG. 71 with a primary electromagnetic interface (1221) coupled with a secondary electromagnetic interface (1231) including an electromagnetic conductor (1232) producing electromagnetically induced heat which can be radiated by means of heat sinks (1232a).

FIG. 73 is a variant of the embodiment shown in FIG. 71 with a primary electromagnetic interface (1241) coupled with a secondary electromagnetic interface (1251) including an electromagnetic conductor (1252) producing electromagnetically induced heat which can be radiated by means of a heat sink (1252a).

FIG. 74 is a functional schematic of the principle of the inventive method showing how the electromagnetic conductor works to conduct the microwave energy by means of induced eddy currents (1265) in a secondary interface conductor (not shown) and by means of a high-frequency magnetic field (1266) perpendicular to the induced currents (1265) wherein an electromagnetic energy transfer can be realised to dry, warm or heat an object (1268) [e.g. a cooked food, a warmed drink, a treated workpiece, etc.].

FIG. 75 is a schematic interior perspective view of another apparatus which can provide the proposed microwave heating method for a heating system comprising a primary electromagnetic interface (not shown) including a microwave energy generator [which can generate microwaves in transverse electric (TE) mode or transverse magnetic (TM) mode] and a secondary electromagnetic interface (1271) which can include one or more electromagnetic conductors (1272, 1282) [which can include interior oscillating structures (1282a)/which can be heat sinks/] conducting the microwave energy and at the same time transforming electromagnetic wave into heat.

FIG. 76 is a schematic perspective view of another apparatus which can provide the proposed microwave heating method for a heating system comprising a primary electromagnetic interface (1291) including a microwave energy generator [which can provide a transverse magnetic field/e.g. by a pair of permanent magnets or electromagnets (1293)/creating eddy currents (1295) [which can have very high frequency] in a freedom joint (1299) which can conduct electromagnetic energy by means of an electromagnetic conductor (1292) which can generate microwaves in transverse electric (TE) mode or transverse magnetic (TM) mode] and a secondary electromagnetic interface (not shown) [which can be coupled with provided flanges (1292a)] which can include one or more electromagnetic conductors conducting the microwave energy and at the same time transforming electromagnetic wave into heat.

FIG. 77 is a schematic side view of electromagnetic conductors (1302a, 1302b, 1302c) which can be configured to conduct the microwave energy and at the same time transform electromagnetic wabe into heat [e.g. by joule loss due to material and/or by internal/external heating structures like heat sinks, meshworks, vents, etc., and/or by means of active/passive thermal air/liquid coupled systems like conduits, thermal exchangers, radiators, fans, etc.]. The conductors (1302a, 1302b, 1302c) can be modularly exchangeable, scallable, couplable, etc.

FIG. 78 is a schematic side view of another apparatus which can provide the proposed microwave heating method for a heating system comprising a primary electromagnetic interface (not shown) including or coupled with a microwave energy generator and a secondary electromagnetic interface (1311) which can include an electromagnetic conductor (1312) [which can be an electromagnetic heat exchanger which can include interior oscillating structures (not shown)/which can be heat sinks/and which can be electromagnetically, thermally insulated, provide valves, controls, sensors, etc.] conducting the microwave energy and at the same time transforming electromagnetic wave into heat [e.g. by means of an air-to-air conduct (1313a), a liquid-to-liquid conduct (1313b), or combinations; or other heat conduct systems which can conduct hot water, hot liquid, steam, hot air, hot gas, etc.; and/or which can include or be coupled with phase change materials, insulants, electromagnetic sheets, chokes, pumps, fans, reservoirs, tanks, etc.].

FIG. 79 is a schematic oblique view of another apparatus which can provide the proposed microwave heating method for a heating system comprising a primary electromagnetic interface (not shown) including or coupled with a microwave energy generator and a secondary electromagnetic interface (1321) which can include an electromagnetic conductor (1322) [which can be an electromagnetic heat exchanger] conducting the microwave energy and at the same time transforming electromagnetic wave into heat [e.g. by means of conducts (1323) which can include valves (1324), etc.].

FIG. 80 is a schematic oblique view of another apparatus which can provide the proposed microwave heating method for a heating system comprising a primary electromagnetic interface (not shown) including or coupled with a microwave energy generator and a secondary electromagnetic interface (1331) which can include an electromagnetic conductor (1332) [which can be an electromagnetic heat exchanger] conducting the microwave energy and at the same time transforming electromagnetic wave into heat [e.g. by means of a heating spiral (1333), etc.].

FIG. 81 is a schematic oblique view of another apparatus which can provide the proposed microwave heating method for a heating system comprising a primary electromagnetic interface (not shown) including or coupled with a microwave energy generator and a secondary electromagnetic interface (1341) which can include an electromagnetic conductor (1342) [which can be an (instantaneous) microwave water heater] conducting the microwave energy and at the same time transforming electromagnetic wave into heat.

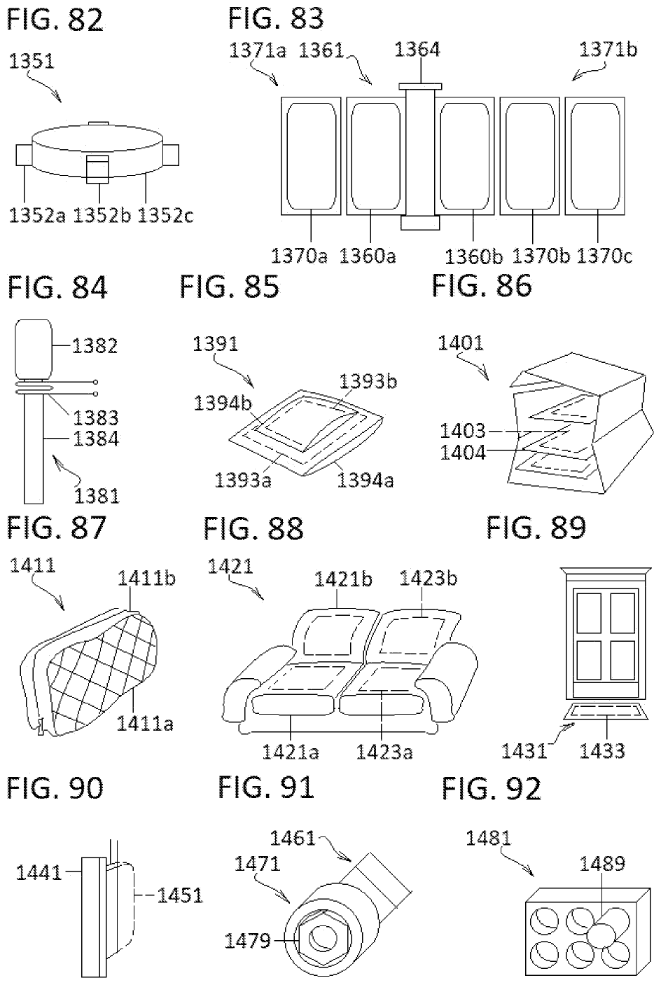

FIG. 82 is a schematic oblique view of another apparatus which can provide the proposed microwave heating method for a heating system comprising a primary electromagnetic interface (not shown) and a secondary electromagnetic interface (1351) which can include electromagnetic conductors (1352a, 1352b, 1352c) [which can be a heating electromagnetic network coupler which can be composed of a cover, an internal electromagnetic heating structure and coupling points] conducting the microwave energy and at the same time transforming electromagnetic wave into heat [e.g. by an outer heating surface].

FIG. 83 is a schematic plan view of an apparatus which can provide the proposed electromagnetic heating method for a heating system comprising a primary electromagnetic interface (1361) including one or more primary coils (1360a, 1360b) [which can be implemented into circuits, interconnected, coupled with electrocomponents, etc.] and a secondary electromagnetic interfaces (1371a, 1371b) including one or more secondary coils (1370a, 1370b, 1370c), the method characterised in that it may comprise the step of providing an electromagnetic field by the primary coils (1360a, 1360b) [e.g. rotating a permanent magnet or electromagnet by a rotor (1364) of a motor, a turbine, a human powered device, etc.]; the step of providing an electromagnetic power transfer between at least one of the primary coils (1360a, 1360b) and at least one of the secondary coils (1370a, 1370b, 1370c) [which can be resonant or non-resonant inductive power transfer]; the step of dissipating heat from at least one of the primary coils (1360a, 1360b) and/or from at least one of the secondary coils (1370a, 1370b, 1370c) [e.g. by means of an open coil heater/e.g. consisting of an exposed wire//Ni-Chrome, etc.// between insulators with various wire gauges, coil diameters, etc., or by means of metal sheath heaters/e.g. consisting of Ni-Chrome resistance wire in a metal sheath with magnesium oxide insulation/preferably with an increased heating area/e.g. hairpin, fold-back, fins, etc./], wherein the steps can be interchanged and/or repeated. Heating relations between the primary (1361) and the secondary interfaces (1371a, 1371b) can be described by the equation R1×11=R2×I2 [further equations can be derived using wire length, temperature factor, unit of magnetic field strength, voltage and impedance, frequency parameter, etc.].

FIG. 84 is a schematic plan view of an apparatus (1381) which can provide the proposed electromagnetic heating method [e.g. as a primary and/or secondary heating interface] and which can include three basic components: a thermal insulation portion (1382) a heating coil (1383) and a heat dissipating device (1384).

FIG. 85 is a schematic perspective view of an apparatus (1391) [which can be a duvet, a pillow; two pillows, etc.] which can provide the proposed electromagnetic heating method [e.g. as a primary and/or secondary heating interface] and which can include three basic components: a thermal insulation portion [which can be a padding, a stuffing, etc.], heating coils (1393a, 1393b) [which can be flexible coils forming heating oscillators] and a heat dissipating device (1394a, 1394b) [e.g. a fabric heating surface].

FIG. 86 is a schematic perspective view of an apparatus (1401) [which can be a foldable cardboard (plywood, polymer, plastic) box, etc.] which can provide the proposed electromagnetic heating method [e.g. as a primary and/or secondary heating interface] and which can include three basic components: a thermal insulation portion [which can be an external material, etc.], heating coils (1403) [which can be flat coils forming heating oscillators and which can be positioned at any part of the box] and a heat dissipating device (1404) [e.g. a shelves heating surface]. The box can optionally include or be wiredly/wirelessly coupled with a (rechargeable) power source a high frequency inverter and can warm foods, drinks, or other objects.

FIG. 87 is a schematic perspective view of an apparatus (1411) [which can be a flexible combined material heating bag having textile sandwiched side walls (1411a) and a central part (1411b) which can be from a transparent plastic; other materials are possible] which can provide the proposed electromagnetic heating method [e.g. as a primary and/or secondary heating interface] and which can include three basic components: a thermal insulation portion [the sandwiched lateral walls which can include thermal insulation, electromagnetic shielding, protective layers, heat reflecting layers, etc.], heating coils (not shown) [which can be flat coils comprised in the lateral walls] and a heat dissipating device [e.g. an inner wall's surface]. A power source (not shown) [which can be a grid, a solar panel, etc.] can be connected wiredly or wirelessly.

FIG. 88 is a schematic perspective view of an apparatus (1421) [which can be an adjustable reversible modular sofa bed having mattresses (1421a) and a pillows (1421b) or other parts] which can provide the proposed electromagnetic heating method [e.g. as a primary and/or secondary heating interface] and which can include three basic components: a thermal insulation portion [e.g. a padding, electromagnetic shielding, protective layers, heat reflecting layers, etc.], heating coils (1423a, 1423b) [which can be flat and flexible coils] and a heat dissipating device [e.g. an outer surface comprised of textile, artificial leather, leather, etc.]. A power source (not shown) [which can be a high frequency inverter] can be connected wiredly or wirelessly. The proposed method can make possible various configurations of the sofa (1421) maintaining its heating functions.

FIG. 89 is a schematic perspective view of an apparatus (1431) [which can be a heated door mat] which can provide the proposed electromagnetic heating method [e.g. as a primary and/or secondary heating interface] and which can include three basic components: a functional layer [e.g. a protective layer, a thermal insulation layer, a heat reflecting layer, etc.], a heating coil (1433) [which can be a flat and flexible coil] and a heat dissipating device [e.g. an upper surface comprised of plastic, rubber, polymer, etc.]. A power source (not shown) [which can include a high frequency inverter, a timer, a sensor, etc., and which can be situated in proximity or vicinity] can be connected wiredly or wirelessly [e.g. by means of an inductive, capacitive, magnetodynamic, electromagnetic, resonant, non-resonant coupling].

FIG. 90 is a schematic perspective view of another apparatus which can provide the proposed microwave heating method for a heating system comprising a primary electromagnetic interface (1441) including or coupled with a microwave energy generator and a secondary electromagnetic interface (1451) which can include an electromagnetic conductor (not shown) [which can be heated to a very high temperature] conducting the microwave energy and at the same time transforming electromagnetic wave into heat [e.g. by means of a heat cutting surface, a heat welding surface, a heat soldering surface, etc.].

FIG. 91 is a schematic oblique view of another apparatus which can provide the proposed microwave heating method for a heating system comprising a primary electromagnetic interface (1461) including or coupled with a microwave energy generator and a secondary electromagnetic interface (1471) which can include an electromagnetic conductor (not shown) [which can be heated to a very high temperature] conducting the microwave energy and at the same time transforming electromagnetic wave into heat [e.g. by means of a heating socket wrench which can heat a nut (1479) and a bolt (not shown) to ease the loosening of the tighten nut (1479); various modifications can be provided—an universal hollow heater with a round hole (as shown), a heated socket wrench, a heated nut driver, an intermediate piece which can have a pin to be mounted upon a socket wrench and which can be directly or indirectly heated by a microwave energy generator; a microwave energy generator can be provided in various shapes and forms, various adapters for difficult-to-access joints can be further provided, the system can be equipped with a mechanism that measures the amount of torque, with sensors, with a compressed air mechanism, etc.; the apparatus can preheat a joint to be loosen with a standard tool or it can combine both functions in one; the principle can be provided by various wrench types/e.g. box-end wrenches, monkey wrenches, adjustable pipe wrenches, etc.).

FIG. 92 is a schematic oblique view of another apparatus which can provide the proposed microwave heating method for a heating system comprising a primary electromagnetic interface (not shown) including or coupled with a microwave energy generator and a secondary electromagnetic interface (1481) which can include an electromagnetic conductor (not shown) [which can be heated to a very high temperature] conducting the microwave energy and at the same time transforming electromagnetic wave into heat [e.g. by means of heating sockets which can heat a liquid receptacle (1489) or other objects].

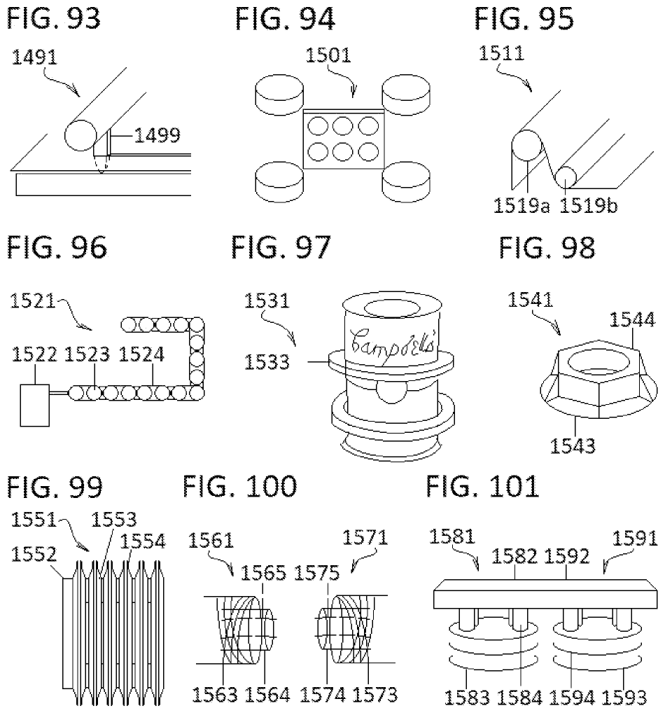

FIG. 93 is a schematic oblique view of another apparatus which can provide the proposed microwave heating method for a heating system comprising a primary electromagnetic interface (not shown) [which can be a head of an apparatus] including or coupled with a microwave energy generator and a secondary electromagnetic interface (1491) which can include an electromagnetic conductor (not shown) [which can be heated to a very high temperature] conducting the microwave energy and at the same time transforming electromagnetic wave into heat [e.g. by means of a working tool (1499) which can be a heat cutting knife, a soldering iron, etc.; which can be in any position, orientation, which can be rotatably, slidably, stowably, etc., mounted, exchangeable, provided with a sensor, etc.]. The apparatus can be computer numerical controlled, manually controlled, etc.

FIG. 94 is a schematic oblique view from the bottom of another apparatus which can provide the proposed microwave heating method for a heating system comprising a primary electromagnetic interface (not shown) including or coupled with a microwave energy generator and a secondary electromagnetic interface (1501) which can include an electromagnetic conductor (not shown) [which can be heated to a very high temperature] conducting the microwave energy and at the same time transforming electromagnetic wave into heat [e.g. by means of a microwave heater which can heat asphalt or other objects].

FIG. 95 is a schematic oblique view of another apparatus which can provide the proposed microwave heating method for a heating system comprising a primary electromagnetic interface (not shown) including or coupled with a microwave energy generator and a secondary electromagnetic interface (1511) which can include an electromagnetic conductor (not shown) [which can be heated to a very high temperature] conducting the microwave energy and at the same time transforming electromagnetic wave into heat [e.g. by means of heating, forming, bending drums (1519a, 1519b), mandrels, or other shapes, forms, etc.].

FIG. 96 is a schematic plan view of an apparatus (1521) [which can be a heating chain] which can provide the proposed electromagnetic heating method and which can include three basic components: a (rechargeable) power source with a processing unit (1522) [which can be a HVAC (heating, ventilation and air conditioning) control module], heating coils (1523) and a heat dissipating device (1524) [e.g. heating chain segments which can provide a coil protection and a coupling mean for the coils (1523) to electromagnetically transfer power and which can dissipate heat/e.g. directly radiate heat, or conduct or convect heat to other air or liquid heating systems/].

FIG. 97 is a schematic perspective view of an apparatus (1531) [which can be a heating set] which can provide the proposed electromagnetic heating method and which can include three basic components: a (rechargeable) power source with a processing unit (not shown) [which can include or be coupled with a power source and which can include or be coupled with a high frequency inverter], heating coils (1533) and a heat dissipating device [e.g. heating rings or other forms or shapes].

FIG. 98 is a schematic perspective view of an apparatus (1541) [which can be a heating nut] which can provide the proposed electromagnetic heating method and which can include three basic components: a high frequency power source including a primary coil (not shown) [which can be disposed in the proximity or in the vicinity], a secondary heating coil (1543) [which can be inductively coupled with the primary coil] and a heat dissipating device (1544) [e.g. a heating tool to heat a bolt, a threaded rod, a rivet, etc.].

FIG. 99 is a schematic front view of an apparatus (1551) [which can be a heating radiator] which can provide the proposed electromagnetic heating method and which can include three basic components: a high frequency power source including a primary heating coil (1552), secondary heating coils (1553) [inductively coupled with the primary coil] and a heat dissipating device (1554) [e.g. ribs, fins, etc.].

FIG. 100 is a schematic perspective view with a partial cutout of an apparatus (1561) [which can be a heating cable] which can provide the proposed electromagnetic heating method and which can include four basic components: a high frequency power source (not shown) [which can include a transformer, a high frequency inverter, a capacitor bank and at least one primary coupling coil], secondary heating coils (1563) [inductively coupled with the primary coil, which can form a (flexible) tube and which can provide distributed inductance and capacitance], an insulating layer (1564) [e.g. comprised of plastic, polymer, etc.] and a supporting core (1565) [e.g. from carbon fibres, linen fibres, etc.]. Alternatively, inductively coupled secondary heating coils (1573) can be provided in an induction heating unit (1571) to heat a workpiece (1574) optionally provided on a mandrel (1575) and including thermometer, sensors, etc. (not shown).

FIG. 101 is a schematic perspective view of an apparatus (1581) [which can be a heater matrix] which can provide the proposed electromagnetic heating method and which can include four basic components: a high frequency power source (1582) [which can include at least one primary coupling coil and a coolant thermal management system which can include a processing unit, sensing circuits, sensors, pumps, valves, tanks, thermal exchangers, etc.], secondary heating coils (1583) [inductively coupled with the primary coil, which can form a sandwiched form which can provide distributed inductance and capacitance] and hot coolant conduits (1584) [e.g. comprised of thermally resistive polymers, metals, metal alloys, etc.]. Alternatively, inductively coupled secondary heating coils (1593) can be provided in an induction baking unit (1591) including a high frequency power source with a primary heating coil (1592) configured to heat a baking plate (1594). The secondary coils (1583, 1593) can work in pairs to provide a circular magnetic path.

Common features of FIGS. 1 to 39 and 83 to 89, 96 to 101.

The components as shown in the drawings can have different layouts, proportions, orientations, materials, etc. Features shown and described in the drawings and the description can be combined, interchanged, multiplied, etc. Some features can be omitted to maintain functionality of the proposed embodiments.

Energy can be transferred through electrical field coupling and/or magnetic field coupling. Electrical current flowing through a primary circuit can create electromagnetic fields in a primary electromagnetic interface. The primary electromagnetic fields can create secondary electromagnetic fields in a secondary electromagnetic interface. The secondary electromagnetic fields in the secondary electromagnetic interface can generate electrical current in a secondary circuit. Primary/secondary electromagnetic interfaces can provide a return path for magnetic fluxes which can propagate (in air, in a liquid) outside the primary/secondary electromagnetic interfaces. A primary electric field in the primary circuit providing condenser action can create a secondary electric field in the secondary circuit. Electrical current flowing through a primary circuit coupled with a primary coupling inductor, capacitor or electromagnetic coupler can create a primary electromagnetic field which can create a secondary electromagnetic field around a secondary coupler which can generate a secondary current in a coupled secondary circuit. The created secondary magnetic fields can oppose the creating primary magnetic fields and the created secondary electric fields can oppose the creating primary magnetic fields to preserve energy. The fields can be resonant or non-resonant according to the present invention.

The invention proposes a repeating electromagnetic interface which in fact can be considered as a specific primary/secondary interface in a system which can perform receiving and transmitting function (eventually other functions of primary/secondary electromagnetic interface/e.g. with different parameters, etc.).

The primary and the secondary electromagnetic interfaces can have a strong (proximity) coupling [e.g. with a coupling factor k>0.1] or a loose (vicinity) coupling [e.g. with a coupling factor k<0.1] when spaced apart from each other to be able to transfer electromagnetic fields in a predominantly non-radiative direct field (resonant or non-resonant) coupling or energy transfer can use predominantly radiative coupling. The lay-out, pattern, dimensions, shapes, numbers, etc., of the primary/secondary electromagnetic components can shape electromagnetic field surrounding electromagnetic interfaces and electromagnetic fields confined within the primary/secondary electromagnetic elements, similarly for electric fields. The shielding can function as a reflector [especially at higher frequencies between 100 MHz and 300 GHz]. e.g. in a parabolic, a 3D modelled form/e.g. conical, pyramidal, diagonal, cavity-backed, etc. wherein sidewalls may be straight, shaped, curved, etc./, custom shaped or it can be a planar reflector, etc.

The system can provide dual orthogonal sense linear polarization configurations by adding a replica of a respective (dipole) antenna system and rotating that system 90° wherein components in both directions can have different dimensions.

Overall design and material choice of the primary/secondary electromagnetic interfaces [e.g. reducing sharp edges and corners, preferably chamfering, radiusing the edges/corners of the primary/secondary magnetic elements, evenly disposing primary/secondary components in selected patterns, choosing a convenient thermal management system, etc.] and of the whole system can provide uniform electromagnetic field distribution and reduce or eliminate electromagnetic fields hot spots.

Energy transfer can be perturbed in the presence of an extraneous object which can influence coupling and result in energy losses. Optimisations of the system can avoid or alleviate perturbations.

The system can use energy transfer repeaters, energy relays, etc. Repeating electromagnetic interfaces can provide energy to devices [e.g. to a heating upholstery of a car] and can simultaneously pass a portion of received energy onto other device in the system [e.g. to a clothing of a person in the car]. The repeaters can receive an electromagnetic energy through a first electromagnetic field with a first plurality of parameters and can generate a second electromagnetic field with a second plurality of parameters. The repeaters can be multiplied to extend the distance range of the system. The repeated electromagnetic fields can have different frequencies from the first electromagnetic fields.

Various applications of the system can have various useful energy exchange and energy transfer efficiency demands. The system can use a passive compensation method and adjustable elements [e.g. in active tuning, autotuning, controlling tuning circuits, etc.] to provide acceptable (economical, tolerable/within environment limits, size limits, cost restrictions/, etc.) energy transfer efficiency. The system can use detuning, frequency hopping, time multiplexing techniques to decouple [e.g. to reduce voltage, current, power transfer, to protect devices with lower power demand from overheating, to protect a heated object from overheating, to defend the system from unauthorised power transfer, to enable authentication of energy sources and coupled loads in the system, etc.].

The system can use inductors, capacitors, distributed inductance, distributed capacitance, distributed filter banks, or combinations [e.g. capacitively loaded (coupling) inductors, etc.]. The components can be fixed or variable, can vary impedance matching, a resonant frequency, etc. The components can be connected in series (resonant or non-resonant circuits) or in parallel (resonant or non-resonant circuits). The embodiments of the electromagnetic interfaces can provide (distributed) inductance, (distributed) capacitance and combinations.

The elements of the invention on a primary side and on a secondary side can be differently sized, oriented [e.g. parallel, substantially parallel, offset, rotated, etc.], structured, coupled, etc. Geometric parameters and distance among primary and secondary electromagnetic interfaces may considerably influence coupling factor. A radiation energy transfer can be reduced if the size of the system components [primary/secondary magnetic elements, primary/secondary conductors, primary/secondary coupling inductors, etc.] can be much less than the wavelength of system operation. Shaping, shielding, sizing, orienting the primary/secondary electromagnetic interfaces [which can be sub-wavelength objects] together with tuning, frequency range and other system parameters setting can help to design electromagnetic fields, to alleviate losses [e.g. primary/secondary conductor absorptive losses, radiation losses, absorption losses/e.g. in extraneous objects/, etc.] and to optimize the system efficiency which can be learned by practicing the invention. The primary/secondary electromagnetic interfaces and their elements can be separated by a thickness of an insulation, a dielectric layer, etc. and can be spaced apart by any distance in which the system can be able to transfer at least partially the electromagnetic fields.

An electric field of a primary/secondary capacitive or electromagnetic coupler which can be a good conductor can be completely perpendicular and a magnetic field can be tangencial and composed of one or more circular magnetic fluxes. Electric field of the primary/secondary coupler providing condenser action can be provided between parallel portions of the primary/secondary conductor [e.g. within a dielectric layer] and can be perpendicular to the circular magnetic fluxes in the primary/secondary magnetic elements. An electron flow between the parallel portions (electrodes) and/or an electric current in the primary/secondary conductor can create circular magnetic fluxes in the primary/secondary magnetic element and vice versa.

A primary/secondary [and terciary, etc. in case of a repeater] magnetic field created by respective primary/secondary circular magnetic fluxes [and terciary fluxes, etc.] can advantageously provide homogenous and (highly) directive electric and magnetic fields or can provide omnidirectional patterns. Directivity can be a significant advantage in applications where the power is only required to be directed over a small area and can prevent it, for example causing interference to other users. Devices coupled with a secondary [and terciary, etc.] magnetic field can have a certain orientation freedom in a 3D space in relation to a position of a primary electromagnetic interface. The orientation freedom can be biggest around an axis (substantially) parallel to the axis of rotation of the primary circular magnetic fluxes and in directions (substantially) perpendicular to the axis which corresponds to a biggest orientation freedom concerning electric fields.

Primary/secondary capacitive or electromagnetic couplers can be (substantially) parallel oriented at about and/or in primary/secondary magnetic elements and/or can be orthogonally, convergently, divergently, focus, random oriented, etc., or combinations. A coupling side of a primary/secondary magnetic element and/or of the primary/secondary conductors [e.g. which can provide internal and/or external condenser action] can be conveniently [e.g. convexly, concavely, cylindrically, etc.] shaped. The primary/secondary electromagnetic field can be in this way correspondingly shaped, the primary/secondary circular magnetic fluxes in the primary/secondary magnetic fields can have a definable plurality of rotation axes. In this way can be formed the relative orientation freedom between energy sources [e.g. charging pads, etc.] and loads [e.g. heating electromagnetic interfaces, etc.].

The primary/secondary conductors [or groups of primary/secondary conductors] can have constant phase, a constant phase 90, 180, etc. degrees out of phase, a variable phase, etc.

The system can be used in a two-coupler energy transfer systems or in multi-coupler systems. A bipolar structure (four-plate structure in case of a capacitive or an electromagnetic couplers) can include primary and secondary electromagnetic interfaces working pairs (groups) which can be provided in a four-plate structure or in any other orientation and pattern. The four-plate structure can be provided in a stacked configuration. In unipolar, bipolar (or other) structures the primary electromagnetic interfaces can have different size, orientation, insulation, shielding, circuitry, etc. than the secondary electromagnetic interfaces. The desired condenser action between capacitive or electromagnetic couplers can influence primary/secondary couplers' shaping, dimensions, etc., used dielectric layers, etc. The condenser action provided between electrodes within a same interface can increase the self-capacitance and voltage stress (a reliable electrical insulation can be a good option or necessity).

The primary and the secondary electromagnetic interfaces can be relatively planar to be integrable into planar electronic devices. Applications of the system can imply heat [e.g. hysteresis loss, energy transfer induced heat, or ambient heat/e.g. when used in tires, etc./. The elements/e.g. binders, polymers, wires, etc. can be fabricated of appropriate heat resistant materials and/or provided with appropriate thermal insulation, etc. The primary and the secondary magnetic elements together with the primary and the secondary conductors and shielding can be designed to be flexible, scrollable, foldable [e.g. can be embedded, integrated, etc. into flexible enclosures/e.g. clothes, cushions, etc./. The primary/secondary magnetic elements can be comprised of elastomers containing magnetic particles, and the like, and the primary/secondary conductors can be fabricated of tressed wires, and the like.

The primary/secondary conductors can be switchable, or can be in a switchable groups. Some of the primary/secondary conductors can be dedicated for a power transfer and others for a signal (data) transfer and provide communication.

The primary/secondary magnetic elements and/or the primary secondary conductors and/or the shielding can be shaped to match various installations [e.g. engineering constructions, furniture, street furniture, etc.], devices [e.g. home appliances, tools, packages, etc.]. They can curve to follow the contours of the device, they can fill a dedicated space within the device, etc. They can have various geometries, shapes, enhancements, ridges, indentations, notches, etc. The primary/secondary electromagnetic interfaces can be shaped to provide a multidirectional energy transfer in a multidirectional area.

Magnetic materials that have ferromagnetic or ferrimagnetic properties can magnify magnetic flux density and can add additional magnetic flux to the already existing flux. Ferrite materials typically show a hysteresis effect between the applied magnetic field and the resulting field. The flux magnification effect of a ferrite rod depends on both the relative permeability of the ferrite material used, and on the form factor, for example the diameter to length ratio. The gyromagnetic effects of certain materials such as ferrite can also be used to increase the circular magnetic flux. The system components can convert electric energy to magnetic energy and back to electric energy. The provided electromagnetic field characterised by the circular magnetic fluxes can be resonant or non-resonant and the system can have a preset coupling coefficient for various applications. Resonance can be achieved within the primary/secondary/repeating electromagnetic interfaces (antennas) and/or with coupled (compensation) electrocomponents.

The system can include an oscillator to convert DC energy into radio frequency energy [e.g. in the frequency range from around 20 kHz to around 300 GHz] and can function at defined frequencies [e.g. about 135 kHz, 200 kHz, 600 kHz, 1 MHz, 6.78 MHz, 10 MHz, 13.56 MHz, 21 MHz, 27.12 MHz, 40.68 MHz, 10 GHz, etc.]. The frequencies for power transfer can be unmodulated.

The electromagnetic energy transfer systems can be enclosed in magnetically permeable packaging, in low-lossy (non-lossy) materials (e.g. certain plastic, carbon fiber, composites, plastic composites. Teflon, Rexolite. ABS (Acrylonitrile butadiene styrene). PVC (Polyvinyl chloride), nylon, rubber, acrylic, polystyrene, ceramics, stone, etc.). The packaging can comprise air, gas, sand, insulation, etc. The plurality of primary and/or secondary magnetic elements and/or primary and/or secondary conductors can be integrated into one device and similarly on a primary side can be one device transferring power to a number of devices on a secondary side or vice versa.

The system can provide wireless data transmission which can provide communication through some form of modulation of the signal [e.g. analog/amplitude, frequency, phase/, digital/amplitude, frequency phase shift keying/, etc.]. Communication can utilize various wireless short range or long range carriers and protocols. Wireless communication can use primary and secondary (eventually repeating) electromagnetic interfaces, a Near Field Communication (NFC), a Radio Frequency Identification (RFID), a Wireless Personal Area Network (WPAN) [e.g. Bluetooth, ZigBee), a Wireless Local Area Network (WLAN) [e.g. Wi-Fi], a Worldwide Interoperability for Microwave Access (WiMax), wireless telephone technologies [e.g. 4G, 5G, etc.], a satellite connection. Communication can further be optical, [e.g. laser, infrared, etc.], acoustic [e.g. underwater acoustic communication, etc.]. Communication can use a separate channel from the circular electromagnetic field or can be combined with the circular electromagnetic field.

The electromagnetic heating systems can comprise a functional, communication, shape compatibility [e.g. can comprise compatible power transfer interfaces, compatible communication interfaces, compatible rechargeable power sources, compatible source management systems, thermal management systems, etc.].

The embodiments of an electromagnetic heating system which can comprise a primary electromagnetic interface including one or more primary coils and a secondary electromagnetic interface including one or more secondary coils wherein a wireless, e.g. (resonant or non-resonant) inductive, capacitive, magnetodynamic, electromagnetic power and data transfer power transfer can be provided between the primary and the secondary electromagnetic interfaces which can be coupled with one or more controllers [e.g. in a form of computers, laptops, smartphones, microcontrollers, chips, etc.] which include one or more integrated circuits (IC) which can include or can be coupled in a near-field mode with a coil, a capacitor, an electromagnetic power transfer interface and with a (transmitting/receiving) antenna (multiple antenna, antenna array) in a far-field mode. The IC in a far-field mode can include a modulating/demodulating section, a central processing unit (CPU), a program memory, a working memory, a data memory, a power generating section, a voltage detecting section. The IC in a near-field mode (e.g. with a coupling coil) can include a resonance capacitor, a full-wave rectification circuit, a smoothing capacitor, a clock generation circuit, a constant voltage circuit, demodulation and modulation circuits, a power circuit, a digital circuit with a memory. The processor and the memory may be packaged into various package types. Various components may also be provided such as power management integrated circuits, sensors (e.g. state of charge sensors, ambient temperature sensors, body sensors, heated object superficial and in depth temperature sensors, etc.), audio codecs, bluetooth controllers, etc. Various substrates may be used including flexible substrates and films. Magnetic sheets (e.g. ferrite or magneto-dielectric material sheets) may be provided to improve electromagnetic field radiation efficiency and to reduce eddy currents.

The primary and secondary circuits can include the primary and the secondary coils, other inductors (coupling or non-coupling), capacitors (coupling or non-coupling) and/or electromagnetic interfaces (coupling or non-coupling). The capacitances and inductances in the system can function as energy storage elements. Electrical energy can be stored in the form of magnetic field provided by the primary or secondary coils or other inductors of the circuit. Magnetic field can be intensified by magnetic conductors which can be provided in a form of coil cores, coil backing plates, etc.

The EHS can provide thermal management systems which can be included by the electric vehicle to thermally manage charging and/or discharging the (swappable) rechargeable power sources. The systems can thermally manage the electric energy generators, chargers of charging stations, charging cables, charging interfaces, rechargeable batteries and/or capacitors and/or energy storage elements of the power sources, etc. The thermal management systems of energy storage elements can include complex technologies. The systems can include ventilators, thermal exchangers, compressors, chillers, condensers, heaters, sensors, pumps, programmable controllers, thermal medium conducts, valves, heat pipes, vapor chambers, heat sinks, fillers, etc. The systems can use thermal exchange with (offshore) water, air, ground, etc.

In electric vehicles or water vessels the system can be used to heat the interior of the vehicle, the persons, animals and/or products transported by the vehicle, auxiliary systems; the transferred energy can be provided for heating, ventilation and air conditioning (HVAC) systems, etc.

The (swappable) rechargeable power sources in the vehicles and/or water vessels can include a package [e.g. a container, a climatised container, a waterproof, watertight, pressurised package, etc.], include and/or be coupled with a source management system which can include power electronics, communication interfaces, various circuit topologies including electrocomponents such as converters, inverters, voltage regulators, power factor corrections, rectifiers, filters, controllers, processors, etc. The source management systems can provide monitoring [e.g. State of Charge (SoC), etc.], calculating, reporting, cell balancing, controlling, etc., functions with regard to the energy management. The source management system can include energy management processors, databases, position identification system [e.g. global positioning satellite (GPS) system receivers] and provide intelligent source management using anticipated track profile and conditions, charging opportunities, past operating experience, etc.

The (swappable) rechargeable power sources can include an energy storage element including a complex technology [e.g. including energy storage, energy transfer, energy harvesting, energy generating, etc.] which can include power electronics, communication interfaces, various circuit topologies, etc. They can be mobile units, compact units, enclosed units, portable units, skid mounted units, and the like.

Common features of FIGS. 40 to 82 and 90 to 95.

The shown apparatuses illustrate the proposed microwave heating method for a heating system comprising a primary electromagnetic interface including a microwave energy generator and a secondary electromagnetic interface including one or more electromagnetic conductors conducting the microwave energy and/or transforming electromagnetic waves into heat.

High-frequency current has a tendency to become distributed near the surface of a conductor. The skin effect can be characterised by the skin depth. The skin depth at which the current density has fallen to 1/e of that at the surface (e=2.718; the exponential constant) may be calculated upon the electrical conductivity, frequency and permeability and is inversely proportional to the electrical conductivity, frequency and permeability. Resistance of the conductor is determined by material's resistivity, a cross sectional area and a length. Resistance decreases as the cross sectional area increases and the resistivity decreases under the same length. The higher the resistivity the higher the joule loss and the heating effect. Resonance sharpness increases as the resistance and Joule loss decrease leading to increasing of microwave energy transfer efficiency. Circuit cumulative energy and circuit energy consumption can be calculated according to specific demands on energy transfer and energy transformation into heat of a system. Various materials can be used as base materials of conductors such as brass, copper, silver, aluminium, steel, etc. Various metals can be used as plating materials such as nickel, iron, copper, silver, etc. Surface plating thickness may be taken into consideration when calculating conductive or heating parameters of the system [e.g. nickel plating can have greater Joule loss than a copper plating at a same thickness, etc.].

Common Requirements on the EHS in Cold Areas

The EHS can be provided in the Arctic, the Antarctic, subpolar, cold areas. In that case, system elements components can be designed to be conform with cold, extremely cold, temporarily cold conditions. The (swappable) rechargeable power sources and other components of the system can be thermally insulated. The electromagnetic heating system can use antifreeze in liquid cooling systems of the electric vehicles or water vessels. Thermal management systems provided to manage charging and/or discharging can include heating systems. The elements can be preferably designed to cope with icing, etc.

No limitations are intended others than as described in the claims. The present invention is not limited to the described exemplary embodiments. It should be noted that various modifications and combinations of the elements of the EHS can be made without departing from the scope of the invention as defined by the claims.

The elements, components, integers, features, standards described in this specification and the used terminology reflect the state of knowledge at the time of the filling of this application and may be developed in the future [e.g. charging standards, charging interfaces, chargers, rechargeable power sources, energy storage elements, communication techniques, fuels, hydrogen production and hydrogen storage techniques, fuel cell technologies, etc.].

### INDUSTRIAL APPLICABILITY

The proposed electromagnetic heating system may provide effective, cheap and lightweight heating systems for vehicles and water vessels vehicles especially in cold areas and/or periods. It can provide a variable, easily to install, portable, etc. systems for heating various constructions, facilities, amenities, etc. It can heat food and drinks, human bodies, animal bodies, plants.

The proposed electromagnetic heating method can provide an electromagnetic (resonant or nonresonant) energy transfer between primary and secondary coils disposed in the proximity or in the vicinity.

The proposed microwave heating method can be realized by means of an apparatus or a system which can combine microwave energy providing, conducting and microwave energy to heat transforming functions.

I claim:

1. An electromagnetic heating system comprising a primary electromagnetic interface including one or more primary coils and a secondary electromagnetic interface including one or more secondary coils, wherein a wireless power transfer is provided between the primary and the secondary electromagnetic interfaces, the electromagnetic heating system characterised in that said one or more primary coils and/or said one or more secondary coil are configured to produce heat.

2. The electromagnetic heating system according to claim 1, wherein at least one said wireless power transfer is selected from the group consisting of inductive power transfers, capacitive power transfers, magnetodynamic power transfers, electromagnetic power transfers, resonant power transfers, non-resonant power transfers, or combinations thereof.

3. The electromagnetic heating system according to claim 1, configured to heat an object in a vehicle and/or in a water vessel, wherein at least one said object is selected from the group consisting of people, animals, products, rechargeable power sources, electronics, or combinations thereof.

4. The electromagnetic heating system according to claim 1, configured to heat a construction, wherein at least one said construction is selected from the group consisting of pools, tanks, roofs, masonry, walls, floors, ceilings, windows, furniture, roads, paths, rooms, utensils, transport means, vehicles, water vessels, or combinations thereof.

5. The electromagnetic heating system according to claim 1, configured to heat a food and/or a drink.

6. The electromagnetic heating system according to claim 1, configured to heat a body wherein at least one said body is selected from the group consisting of human bodies, animal bodies, plants, or combinations.

7. The electromagnetic heating system according to claim 1, wherein said primary and/or said secondary electromagnetic interface is provided with a heat dissipating device.

8. The electromagnetic heating system according to claim 1, wherein said primary and/or said secondary coil is coupled with an electrocomponent, wherein at least one said electrocomponent is selected from the group consisting of electronic devices, power devices, sensors, targets, actuators, antennas, amplifiers, resonators, rectifiers, filters, thyristors, semiconductors, inverters, converters, frequency converters, modulators, encoders, decoders, transformers, voltage regulators, power factor corrections, compensations, power electronics, controllers, processors, integrated circuits, timers, inductors, capacitors, shunts, resistors, diodes, varactors, switches, rechargeable power sources, power sources, smart grids, power grids, data transmission systems, the Internet, navigation systems, satellite navigation systems, source management systems, solar energy systems, wind energy systems, hydrogen energy systems, electric motors, driving units, distributed electrocomponents, electrocomponents arrays, switchable electrocomponents, controllable electrocomponents, electric energy generators, coil cores, coil backing plates, coil backing sheets, magnetic conductors, electrical conductors, or combinations thereof.

9. The electromagnetic heating system according to claim 1, wherein said primary and/or said secondary coil form an oscillator.

10. The electromagnetic heating system according to claim 1, configured to use resonant and/or harmonic frequencies.

11. The electromagnetic heating system according to claim 1, further comprising a repeating electromagnetic interface to extend said wireless power transfer.

12. The electromagnetic heating system according to claim 1, further providing an electromagnetic coupling regulation.

13. The electromagnetic heating system according to claim 1, wherein said primary and/or said secondary electromagnetic interface is thermally coupled with a heating system, wherein at least one said heating system is selected from the group consisting of air heating systems, liquid heating systems, phase change materials heating systems, or combinations thereof.

14. The electromagnetic heating system according to claim 1, configured to be at least partially buoyant.

15. The electromagnetic heating system according to claim 1, provided with an insulation.

16. The electromagnetic heating system according to claim 1, provided with a heat accumulating material.

17. The electromagnetic heating system according to claim 1, wherein said system is modularly exchangeable and/or scallable.

18. An electromagnetic heating method for a heating system comprising a primary electromagnetic interface including one or more primary coils and a secondary electromagnetic interface including one or more secondary coils, the method characterised in that it comprises:
the step of providing an electromagnetic field by said one or more primary coils;
the step of providing an electromagnetic power transfer between at least one of said one or more primary coils and at least one of said one or more secondary coils;
the step of dissipating heat from at least one of said one or more primary coils and/or from at least one of said one or more secondary coils,
wherein the steps can be interchanged and/or repeated.

19. A microwave heating method for a heating system comprising a primary electromagnetic interface including or coupled with a microwave energy generator and a secondary electromagnetic interface including one or more electromagnetic conductors, the method characterised in that it comprises:
the step of providing said microwave energy by means of said microwave energy generator;
the step of conducting said microwave energy by said one or more electromagnetic conductors;
the step of transforming electromagnetic wave into heat.

20. The microwave heating method according to claim 19, wherein said electromagnetic conductors are configured to have the same or substantially the same resonant frequency as said primary electromagnetic interface.
